(19) United States
(12) Patent Application Publication
(10) Pub. No.: US 2026/0069489 A1
(43) Pub. Date: Mar. 12, 2026

(54) MYOFASCIAL MAT WITH MASSAGERS AND ROLLERS

(71) Applicant: CHIRP INNOVATION, INC., Lehi, UT (US)

(72) Inventors: Brian Connolly Nielson, American Fork, UT (US); Reeve Stewart Sudweeks, Lehi, UT (US); Weston N. Hills, Kamas, UT (US); Jason Lee Walton, Draper, UT (US); Caden-Thomas Atwood Wakefield, Edgewood, WA (US); Tate Sherman Stock, Draper, UT (US)

(21) Appl. No.: 18/826,528

(22) Filed: Sep. 6, 2024

(51) Int. Cl. A61H 15/00

(52) U.S. Cl. CPC A61H 15/0078; A61H 2201/1611; A61H 2201/1623; A61H 2201/1669; A61H 2203/0456

(57) ABSTRACT

A device includes a track, a first carriage, and a second carriage. The first carriage has one or more first massagers and a first actuator configured to move the first carriage along the track. The second carriage has a second actuator configured to move the second carriage along the track, a first arm, a second arm, and a roller assembly coupled to the first arm and the second arm. The roller assembly has an axle and one or more rollers disposed about the axle. A third actuator of the second carriage is configured to move the first arm and the second arm to adjust a position of the roller assembly.

### BACKGROUND

Physical therapists and/or chiropractors utilize roller tables to decrease back pain, increase mobility, relieve pressure on discs, massage muscles, and increase blood flow in a patient's spine. For example, patients may lie down on the roller table and wheels of the roller table may roll along muscles next to the patient's spine. However, roller tables are often expensive, inaccessible, and uncomfortable. Moreover, roller tables fail to accommodate different patients.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features. The components, devices, and/or apparatuses depicted in the accompanying figures are not to scale and components within the figures may be depicted not to scale with each other.

FIG. 1 illustrates an example myofascial mat that provides therapeutic relief, according to examples of the present disclosure.

FIGS. 2A-2C illustrate a cover of the myofascial mat of FIG. 1 removed, showing components disposed within an internal compartment of the myofascial mat, according to examples of the present disclosure.

FIG. 3 illustrates example carriages of the myofascial mat of FIG. 1 for providing therapeutic relief, according to examples of the present disclosure.

FIG. 4 illustrates example carriages of the myofascial mat of FIG. 1 and an engagement with a track for adjusting a position relative to a user laying on the myofascial mat, according to examples of the present disclosure.

FIGS. 5A-5C illustrate details of a first carriage of the myofascial mat of FIG. 1, according to examples of the present disclosure.

FIGS. 6A and 6B illustrate details of a second carriage of the myofascial mat of FIG. 1, according to examples of the present disclosure.

FIGS. 7A-7D illustrate details of the second carriage of FIGS. 6A and 6B and a roller assembly of the second carriage, according to examples of the present disclosure.

FIG. 8 illustrates an example axle and arms of the second carriage of FIGS. 6A and 6B that engage with a roller assembly of the second carriage, according to examples of the present disclosure.

FIG. 9 illustrates example arms and a roller assembly of the second carriage of FIGS. 6A and 6B, according to examples of the present disclosure.

FIG. 10 illustrates example arms of the second carriage of FIGS. 6A and 6B, according to examples of the present disclosure.

FIGS. 11A-11D illustrate details of the arms of FIG. 10, according to examples of the present disclosure.

FIGS. 12A-12C illustrate details of the roller assembly of FIGS. 6A and 6B, according to examples of the present disclosure.

FIG. 13 illustrates an example axle of the roller assembly of FIGS. 12A-12C, according to examples of the present disclosure.

FIG. 14 illustrates an example engagement between the arms of FIG. 10 and the axle of FIG. 13, according to examples of the present disclosure.

FIGS. 15A-15D illustrate details of an example base of the myofascial mat of FIG. 1, according to examples of the present disclosure.

FIGS. 16A and 16B illustrate an example storage compartment of the myofascial mat of FIG. 1, according to examples of the present disclosure.

FIG. 17 illustrates an alternate roller assembly of the second carriage of FIGS. 6A and 6B, according to examples of the present disclosure.

FIG. 18 illustrates an alternate roller assembly of the second carriage of FIGS. 6A and 6B, according to examples of the present disclosure.

FIGS. 19A and 19B illustrate example paths of rollers of the myofascial mat of FIG. 1, according to examples of the present disclosure.

FIG. 20 illustrates an example path of rollers of the myofascial mat of FIG. 1, according to examples of the present disclosure.

FIG. 21 illustrates an example remote of the myofascial mat of FIG. 1, according to examples of the present disclosure.

FIG. 22 illustrates an example use of the myofascial mat of FIG. 1, according to examples of the present disclosure.

FIG. 23 illustrates an example process performed at least in part by the myofascial mat of FIG. 1, according to examples of the present disclosure.

### DETAILED DESCRIPTION

This application is directed, at least in part, to a myofascial mat that provides therapeutic relief, treats muscular pain, myofascial pain, trigger points, etc. In an embodiment, a user may lay on the myofascial mat, and one or more massagers and/or rollers of the myofascial mat may provide therapeutic relief. The massagers may provide therapeutic relief to a neck of the user, while the rollers may provide therapeutic relief to a back (e.g., along a spine) of the user. In an embodiment, the massagers may be moveable along a track of the myofascial mat to position the massagers adjacent to the neck. Additionally, the rollers may be moveable along the track to provide therapeutic relief to different portions of the back (e.g., between the cervical and the lumbar, sacrum, etc.). In an embodiment, the user may control an amount of pressure, therapeutic relief, etc., provided by the massagers and/or rollers. By way of example, the rollers may be raised and lowered to provide varying amounts of pressure along different portions of the back. As such, the device may be used in varying ways to provide or treat muscular pain, myofascial pain, trigger points, and the like.

In an embodiment, the myofascial mat may include a base (e.g., frame, housing, platform, etc.) configured to lie on a surface, such as a floor, table, etc. In an embodiment, the base includes one or more feet, pads, etc., to secure the myofascial mat on the surface, prevent the myofascial mat from slipping on the surface, reorienting, etc. Foam may be coupled to the base and form a portion of the myofascial mat on which the user lays. The foam may be ergonomically molded to conform to the user and increase a comfort of the user. As will be discussed herein, the base and/or the foam may define an internal compartment (e.g., cavity, section, etc.) in which components of the myofascial mat are disposed. A cover may be disposed over the internal compartment to conceal the components of the myofascial mat. The cover may be coupled to the base, the foam, or other brackets, mounts, etc. via fasteners, snap-fits, pressure-fits, etc.

Although described herein as a mat, the myofascial mat may represent a cushion, pad, seat, table, platform, pad, etc., on which the user is configured to lay. In an embodiment, all or a portion of the back of the user may lie on the myofascial mat.

In an embodiment, the myofascial mat includes a first carriage (e.g., movable assembly, sub-assembly, etc.) and a second carriage (e.g., moveable assembly, sub-assembly, etc.) at least partially disposed within the internal compartment. The first carriage may include the massagers that provide therapeutic relief to the neck. The second carriage may include the rollers that provide therapeutic relief to the back. The first carriage and the second carriage are configured to move along the track to position the massagers adjacent to the neck and provide therapeutic relief to different parts of the back, respectively.

The first carriage and the second carriage may include actuator(s) that power, move, translate, etc., the first carriage and the second carriage, respectively, along the track. The first carriage and the second carriage may be independently movable via respective actuators. Additionally, the first carriage and the second carriage may include suitable gear(s) (e.g., spur, planetary, worm, etc.) that drive the first carriage and the second carriage along the track, respectively. The base may include a gear rack and gears of the first carriage and the second carriage may engage with the gear rack. For example, the gears of the first carriage and the second carriage may transfer motion of the actuator(s) to drive the first carriage and the second carriage along the gear rack. As the gears are driven to engage the gear rack, the first carriage and the second carriage move along the track. For example, the first carriage and the second carriage may include spur gears that engage with the gear rack to drive the first carriage and the second carriage along the track, respectively. Any number of gears may be used to transfer the motion of the actuator(s) to move the first carriage and the second carriage along the track, respectively. Moreover, any number of gears may be used to adjust a speed, torque, force, etc.

The track may be disposed in the internal component, such as along a bottom of the internal compartment. The first carriage and the second carriage may engage with the track, but the massagers and the rollers extend external to the internal compartment for engaging with the user. The cover may be disposed over the massagers and the rollers to provide the myofascial mat with a clean and aesthetic appearance. The cover may also provide a laying surface on which the user lays their back. However, the massagers and the rollers are configured to apply therapeutic relief through the cover and to the user.

One or more straps may be disposed across the internal compartment, below the cover, for example, to support the user over a span of the internal compartment, or stated alternatively, to prevent the user from sinking, sagging, dropping, etc., into the internal compartment. The straps may be disposed across the internal compartment in different directions to at least partially support the weight of the user. The straps may not interfere with the massagers or the rollers or impede movement of the first carriage and the second carriage along the track.

In an embodiment, the track may include a first end and a second end spaced apart from the first end. The first carriage may be located closer to the first end of the track than the second carriage, while the second carriage may be located closer to the second end of the track than the first carriage. When the user lays on the myofascial mat, the head of the user may be positioned adjacent to the first end of the track. The lumbar, lower back, etc., may be positioned closer to the second end of the track.

In an embodiment, the track may include different shapes, slopes, contours, etc. For example, the track may be planar, inclined, sloped, curved, etc. In an embodiment, a first section (e.g., portion, length, etc.) of the track may be planar while a second section (e.g., portion, length, etc.) of the track may be inclined, relative to the first section. The second section of the track may be inclined to move the rollers towards the user and/or bring the rollers into engagement with the lumbar region of the spine. The track may be shaped to accommodate a curvature, contour, etc., of the of the spine. In an embodiment, the first carriage may move along the first section of the track. The second carriage may move along the first section and/or the second section of the track. Although described as having different sections, however, the track may be continuous between the first end and the second end.

The track may include a first rail and a second rail engaged by the first carriage and the second carriage. The first rail and the second rail maintain an orientation of the first carriage and the second carriage within the myofascial mat, or as the first carriage and the second carriage move between the first end and the second end of the track. Although described as including two rails, in an embodiment, the track may include one rail or more than two rails.

As introduced above, the myofascial mat may accommodate users with different characteristics (e.g., height, weight, shape, etc.). In an embodiment, the first carriage and/or the second carriage may be moved to different locations along the track based at least in part on the characteristics of the user. In this manner, the myofascial mat may provide therapeutic relief to a user who is six feet tall, a user who is five feet tall, a user who is four feet tall, and so forth. In an embodiment, when the user lays on the myofascial mat, the first carriage may move along the track until the massagers are in position adjacent to the neck.

The location of the first carriage may be used to determine a length of the track that the second carriage traverses. More particularly, upon laying on the myofascial mat, the first carriage may move in a direction away from the first end of the track, towards the second end or towards the neck. The first carriage may continue to move towards the second end until the massagers are positioned adjacent to the neck. With the massagers in place adjacent to the neck, the second carriage may be configured to move along a length of the track disposed between the first carriage and the second end. As the second carriage moves along the length of the track the first carriage may remain stationary, next to the neck of the user.

For taller users, the length of the track along which the second carriage moves may be longer in length. That is, given that the first carriage may not move as much in the direction away from the first end to position the massagers adjacent to the neck, the length of the track that the second carriage traverses may be longer for taller users as compared to shorter users. As such, for taller users, the second carriage may move along a greater length of the track than for shorter users. The location of the first carriage on the track, when positioned adjacent to the neck, may therefore be used to determine the length of the track along which the second carriage moves.

In an embodiment, sensor(s) may be used to determine whether the massagers are disposed adjacent to the neck. For example, the sensor(s) may be used to sense a presence of the massagers adjacent to the neck. Example sensor(s) include proximity sensor(s), contact sensor(s), resistive sensor(s), etc. As the first carriage moves along the track and adjacent to the neck, the massagers contact, engage, abut, etc., the neck, shoulders, etc. of the user. Upon contact, a resistance may be applied to the actuator(s). This resistance may be measured by the sensor(s) to determine that the massagers are positioned adjacent to the neck of the user. The location of the first carriage may be recorded, determined, etc., for use in controlling the second carriage.

Additionally, or alternatively, the position of the first carriage may be controlled manually by the user. For example, buttons, switches, levers, toggles, etc., of the myofascial mat may be used to move the first carriage and, correspondingly, the massagers into position adjacent to the neck. The myofascial mat may also include a remote to adjust the position of the massagers. For example, the remote may include toggles that moves the first carriage along the track. In this manner, the user may position the first carriage to their desire, comfort, etc. In an embodiment, the cover may include a pocket, pouch, etc. in which the remote is stored.

Still, in an embodiment, the myofascial mat may access information stored in a profile of the user for positioning the first carriage along the track. The profile may indicate a predetermined location of the first carriage on the track, characteristic(s) of the user, preference(s) of the user, and so forth. The information stored in the profile may be used to position the first carriage along the track. Profiles for different users may be used to configure the myofascial mat accordingly. The user may also set their profiles once the first carriage is moved into position and the position of the first carriage along the track may be recorded for future use.

In an embodiment, the massagers may represent nodules, knobs, bumps, balls, or other myofascial features. The massagers may have a smooth surface finish, textured surface finish, etc. The massagers may include a first massager located adjacent to a first side of the neck of the user (e.g., left side) and a second massager located adjacent to a second side of the neck of the user (e.g., right side). The massagers may be powered to rotate, translate up and down (e.g., into and out of the neck), etc., to provide different forms of therapeutic relief. The massagers may be made of foam, rubber, plastic, and/or combinations thereof.

As introduced above, the second carriage is configured to move along a length of the track between the first carriage and the second end. In an embodiment, the second carriage may move along a portion of the length of the track between the first carriage and the second end or an entirety of the length between the first carriage and the second end. In an embodiment, the length of the track between the first carriage and the second end along which the second carriage traverses may be based on the preference(s) of the user. For example, the user may prefer to have the second carriage remain stationary at a particular location on the track to provide therapeutic relief to a particular portion of the back (e.g., lumbar), translate along a specific portion of the track, etc. During these instances, the rollers may move into and out of the back of the user, move in a circular fashion, etc.

The second carriage includes a roller assembly, which may have the rollers mounted about axles. In an embodiment, the rollers may move along a path as the second carriage moves along the track. For example, the second carriage may remain engaged with the track, but the rollers may move up and down as the second carriage moves along the track. The rollers that therefore be controlled independently of the second carriage. In an embodiment, the path of the rollers may include segments, portions, sections, etc., that are planar, curved, sinusoidal, etc., to follow a curvature of the back. The segments of the path that are planar, curved, sinusoidal, etc., may be based at least in part on the length of the track over which the second carriage is configured to traverse. For example, a first segment of the path may correspond to the thoracic region of the spine and a second segment of the path may correspond to the lumbar region of the spine. In an embodiment, the first segment may be planar and the second segment may be curved.

A length of the first segment and a length of the second segment may be based upon the position of the first carriage such that the rollers provide therapeutic relief along the first segment to the thoracic region of the spine and along the second segment to the lumbar region of the spine. This enables the myofascial mat to accommodate users of different characteristics. As such, a length of the first segment of the path may be longer for a taller user (e.g., six feet) than the first segment of the path for a shorter user (e.g., five feet).

In an embodiment, the rollers may apply different pressures to the user along the path. For example, the amount of pressure applied by the rollers may be based on the locations of the rollers along the path. In an embodiment, the pressure applied by the rollers over the first segment may be constant, while the pressure applied by the rollers over the second segment may be dynamic. Actuator(s) may be configured to move the rollers in an up-and-down fashion, for example, into and out of the back of the user to apply different amounts of pressure. In an embodiment, the actuator(s) may be coupled to one or more arms that cause the roller(s) to move into and out of the back. In an embodiment, the one or more arms may resemble cantilever arms that raise and lower the rollers (or the roller assembly).

Alternatively, cam mechanism(s) may be coupled to the actuator(s). As the actuator(s) are actuated, the cam mechanism(s) may rotate the rollers into or out of the back to apply different levels of pressure. In an embodiment, the amount of pressure applied by the rollers may be based on the preference(s) of the user, such as preference(s) stored in association with the profile of the user. Moreover, toggles, buttons, levers, etc., may be configured to adjust the amount of pressure applied by the rollers. In an embodiment, the rollers may be raised and lowered by varying degrees, such as 10 millimeters, 30 millimeters, etc. The rollers may be incrementally raised by different amounts (e.g., 1 millimeter, 5 millimeters, etc.). Sensor(s) may be used to measure or determine a position of the rollers for use in determining whether the rollers may be further raised or lowered.

As the second carriage moves along the track, the rollers may engage with the user, through the cover, to provide therapeutic relief. Although described as rollers, the rollers may represent wheels that roll, engage, or traverse along portions of the back of the user. The roller assembly may include any number of the rollers to provide therapeutic relief. In one example, the roller assembly may include a first roller and a second roller mounted about an axle. The first roller may engage along a first side of the spine of the user (e.g., left side of the spine), and the second roller may engage along a second side of the spine (e.g., right side of the spine), for example. The rollers may have a smooth surface finish, textured surface finishes, etc. The rollers may be made of foam, rubber, plastic (e.g., TPE), and/or combinations thereof.

In an embodiment, the rollers may be interchanged with one another to provide different therapeutic relief. For example, first rollers may have a first durometer, size, shape, etc., to provide a therapeutic relief different than second rollers with a second durometer, size, shape, etc. In an embodiment, the myofascial mat may include a storage compartment that stores the different rollers. Those rollers not being used may be stored in the storage compartment. Although described as interchanging the rollers, in an embodiment, roller assemblies with different rollers may be interchanged.

The storage compartment may be accessible via a lid rotatably coupled to the base. For example, the lid may rotate between a closed position in which access to the storage compartment is restricted and an open position in which access to the storage compartment is permitted. In an embodiment, the lid may correspond to a seating area of the myofascial mat. For example, in the closed position of the lid, a user may sit on a top of the lid. Thereafter, the user may lay backward on the myofascial mat. The top of the lid may be padded, for example, with foam.

In an embodiment, the lid may be secured in the closed position via a latch mechanism (e.g., lock, hook, etc.). For example, the latch mechanism may lock or otherwise secure the lid in the closed position. However, the latch mechanism may be engaged, actuated, etc., to transition the lid to the open position. In an embodiment, a sensor may detect a position of the lid, or whether the latch mechanism is engaged, for at least partially controlling an operation of the myofascial mat. When the lid is in the open position, the myofascial mat may be restricted from operating and providing therapeutic relief to the user. For example, the first carriage and the second carriage may be prevented from moving along the track. Comparatively, when the lid is in the closed position, the myofascial mat may be permitted to operate and provide therapeutic relief.

In an embodiment, the second end of the track and/or the second carriage may be accessible in the open position of the lid to allow the rollers to be interchanged. For example, based at least in part on lid opening, the second carriage may be moved to the second end. Since the second end is accessible when the lid is in the open position, moving the second carriage to the second end permits the rollers to be conveniently interchanged. In an embodiment, the user may actuate a button, switch, etc., to move the second carriage to the second end of the track, etc. If the button is pressed, but the lid is moved to the open position, movement of the second carriage may be halted. If movement of the second carriage is halted before the roller assembly is accessible via the storage compartment, the user may move the lid to the closed position whereby movement of the second carriage may be resumed. As another example, if the lid is in the open position and the user presses the button to move the second carriage to the second end, movement may be restricted until the lid is moved to the closed position.

In an embodiment, the user may interact with a mobile device to at least partially control the operation of the myofascial mat. For example, the mobile device (e.g., tablet, wearable, phone, etc.) may be used to configure the myofascial mat according to characteristic(s) of the user, preference(s) of the user, etc. Alternatively, as indicated above, the user may interact with buttons, toggles, switches to at least partially control the myofascial mat. Additionally, the profile of the user may be used to control the myofascial mat. For example, in addition to controlling a location of the first carriage along the track, for example, or the pressure applied by the rollers, the profile may store other preferences, such as speeds of the second carriage along the first segment, second segment, etc.

In an embodiment, the myofascial mat may include heating element(s) that provide heat therapy. In an embodiment, the heating element(s) may be disposed within the foam and/or the cover. The user may control an amount of heat, a location of the heat, etc. provided by the heating element(s). Such preference(s) may also be stored in association with the profile of the user. The myofascial mat may control preference(s) for any number of users, where each of the users may have a profile that indicates their preference(s).

The present disclosure provides an overall understanding of the principles of the structure, function, device, and system disclosed herein. One or more examples of the present disclosure are illustrated in the accompanying drawings. Those of ordinary skill in the art will understand and appreciate that the devices, the systems, and/or the methods specifically described herein and illustrated in the accompanying drawings are non-limiting embodiments. The features illustrated or described in connection with one embodiment or instance may be combined with the features of other embodiments or instances. Such modifications and variations are intended to be included within the scope of the disclosure and appended claims.

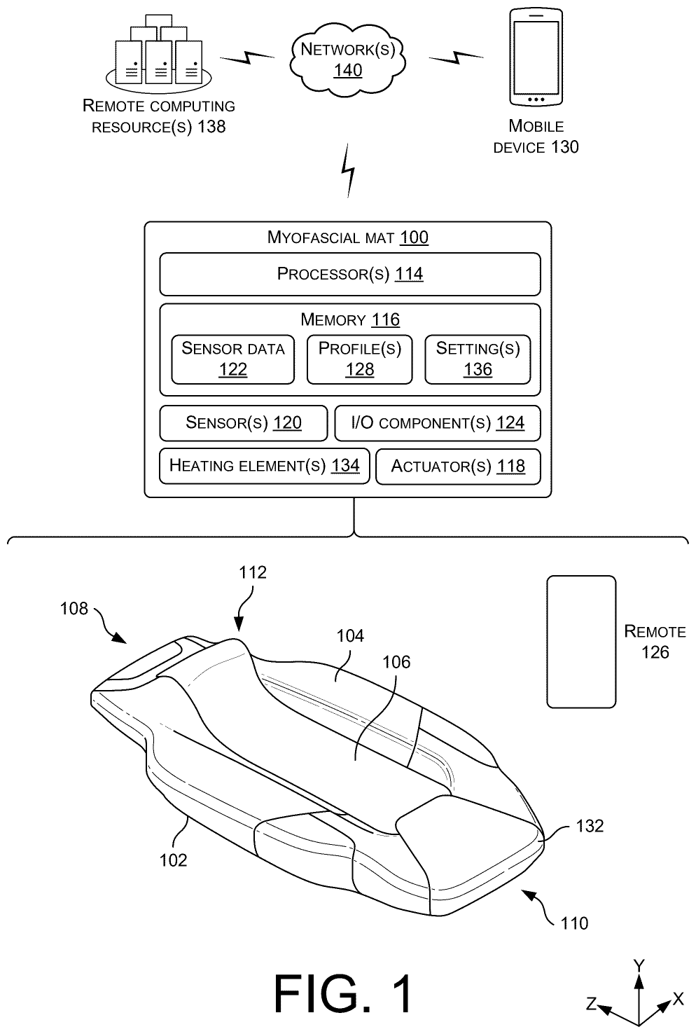

FIG. 1 illustrates an example myofascial mat 100 that provides therapeutic relief to a user, according to examples of the present disclosure. In an embodiment, the myofascial mat 100 may be alternatively referred to or be considered a device, apparatus, assembly, system, etc. Moreover, although described herein as a mat, the myofascial mat 100 may represent a cushion, pad, seat, table, platform, etc., on which the user is configured to lay. As will be explained herein, the user may lay on the myofascial mat 100 and one or more massagers and/or rollers of the myofascial mat 100 may provide therapeutic relief to the neck and/or back of the user.

The myofascial mat 100 may include a base 102, one or more pieces of foam 104 coupled to the base 102, and a cover 106 disposed over components of the myofascial mat 100. The cover 106 may also be disposed over the pieces of foam 104. The base 102 may be disposed on a surface, such as a floor. The pieces of foam 104 may be coupled to the base 102 and form a portion of the myofascial mat 100 on which the user lays. The pieces of foam 104 may be ergonomically molded to conform to the user. The cover 106 may be coupled to the base 102, the pieces of foam 104, and span between sides, ends, etc., of the myofascial mat 100. In between the pieces of foam 104, for example, the cover 106 may be disposed over the components of the myofascial mat 100.

The myofascial mat 100 may include a first end 108 and a second end 110 spaced apart from the first end 108 (e.g., in the Z-direction). In an embodiment, the user may seat themselves at the second end 110 and lay back onto the myofascial mat 100, with their head being positioned towards the first end 108. The myofascial mat 100 may include the massagers that provide therapeutic relief to the neck of the user and the rollers that provide therapeutic relief to the back of the user. The massagers and the rollers act through the cover 106 to contact, engage, etc., the user to provide therapeutic relief. The myofascial mat 100 may have a head rest location 112 corresponding to the massagers, where the massagers push, act, etc., against the cover 106 in an upward manner (e.g., Y-direction) to engage the user. The rollers may similarly act on the cover 106 to provide therapeutic relief to the back.

The myofascial mat 100 may be configured to accommodate different users. For example, a location of the massagers (e.g., between the first end 108 and the second end 110) may be based on characteristic(s) of the user. As the user lays on the myofascial mat 100, the location of the massagers may be adjusted to be positioned adjacent to their neck. In an embodiment, the massagers may be disposed on a first carriage that translates, traverses, moves, etc. along a track disposed within the myofascial mat 100. Moving the first carriage along the track positions the massagers at different locations to accommodate different users. For example, for a user of a first height the massagers (or the head rest location 112) may be at a first location, for a user of a second height the massagers (or the head rest location 112) may be at a second location, and so forth. Likewise, in an embodiment, the rollers may be disposed on a second carriage that translates, traverses, moves, etc. along the track to position the rollers adjacent to the back (e.g., spine) of the user.

The first carriage and the second carriage may traverse along the same track. In an embodiment, once the first carriage is moved into position adjacent to the neck, the first carriage may remain stationary. Comparatively, the second carriage may move along a length of the track to provide therapeutic relief along the back. For example, the second carriage may move along the track (e.g., in the Z-direction), up and down the back of the user such that the rollers provide therapeutic relief between a thoracic region and a lumbar region of the spine. As will be explained herein, a movement of the second carriage along the track, or a length of the track that the second carriage traverses, may be limited by the location of the first carriage on the track.

The myofascial mat 100 is shown including processor(s) 114 and memory 116, where the processor(s) 114 may perform various functions and operations associated with controlling the myofascial mat 100. The memory 116 may store instructions executable by the processor(s) 114 to perform the operations described herein. For example, the myofascial mat 100 may include actuator(s) 118 that move the first carriage (or the massagers) along the track and into position adjacent to the neck. The actuator(s) 118 may also move the second carriage (or the rollers) along the track. The first carriage and the second carriage may move independently of one another.

In an embodiment, the location of the first carriage may be used to determine a length of the track along which the second carriage moves. To briefly explain, upon laying on the myofascial mat 100, the first carriage may move in a direction away from the first end 108, towards the second end 110. This movement may bring the first carriage towards the neck. The first carriage continues to move toward the second end 110 until the massagers are positioned adjacent to the neck. With the massagers in place, the second carriage may be configured to move along a length of the track disposed between the first carriage and an opposite end of the track (e.g., adjacent to the second end 110). In this manner, the myofascial mat 100 may accommodate users with different characteristics (e.g., height, etc.).

In an embodiment, the myofascial mat 100 may include sensor(s) 120 that are used to determine whether the massagers are disposed adjacent to the neck. For example, the sensor(s) 120 may sense a presence of the massagers adjacent to the neck. Example sensor(s) 120 include proximity sensor(s), contact sensor(s), limit switches, resistive sensor(s), etc. The sensor(s) 120 may generate sensor data 122 that is analyzed, compared to thresholds, for example, to determine whether the massagers are adjacent to the neck. As the first carriage traverses along the track to be in position adjacent to the neck, the massagers may come into contact, engage, abut, etc., the neck, shoulders, etc. of the user. Upon contact, a resistance may be applied to the actuator(s) 118. This resistance may be measured by the sensor(s) 120 and used to determine that the massagers are positioned adjacent to the neck.

Additionally, or alternatively, the position of the first carriage may be controlled manually by the user. For example, I/O component(s) 124 of the myofascial mat 100, such as buttons, switches, levers, toggles, etc., may be actuated by the user to move the first carriage and, correspondingly, the massagers into position. In this manner, the user may position the first carriage to their desire, comfort, etc. For example, once lying down on the myofascial mat 100, the user may utilize the I/O components 124 to move the head rest location 112 until positioned adjacent to the neck. Still, in an embodiment, the user may utilize a remote 126 having I/O components for moving the massagers into position. In an embodiment, the cover 106 may define a pocket in which the remote 126 may be stored.

In an embodiment, once in position, the location of the first carriage may be recorded and stored in associated with a profile 128 of the user. In future instances, the recorded location of the first carriage may be used to position the first carriage. For example, across different users that utilize the myofascial mat 100, the location of the first carriage may be different. The profile 128 may indicate predetermined, preconfigured, etc., locations of the first carriage utilized by the myofascial mat 100 to control the actuator(s) 118 and position the first carriage. In this manner, the user may not have to manually adjust the head rest location 112 in between uses, but may instead rely on stored settings in the profile 128. In an embodiment, the profile 128 may be selected via the I/O component(s) 124, the remote 126, a mobile device 130 communicatively coupled to the myofascial mat 100, and so forth.

In an embodiment, the rollers may move along a path as the second carriage moves along the track. For example, the second carriage may remain engaged with the track, but the rollers may move up and down (e.g., in the Y-direction) as the second carriage moves along the track (e.g., in the Z-direction). In an embodiment, the path of the rollers may include segments that are planar, curved, sinusoidal, etc., to follow a curvature of the back. For example, a first segment of the path may include a contour that corresponds to the thoracic region of the spine and a second segment of the path may include a contour that corresponds to the lumbar region of the spine. The first segment may be planar and the second segment may be curved to follow a general curvature of the spine.

In an embodiment, a length of the first segment and/or a length of the second segment may be based upon the position of the first carriage on the track such that the rollers provide therapeutic relief along the first segment to the thoracic region of the spine and along the second segment to the lumbar region of the spine. This further enables the myofascial mat 100 to accommodate users of different characteristics. As such, a length of the first segment of the path may be longer for a taller user (e.g., six feet) than the first segment of the path for a shorter user (e.g., five feet).

In an embodiment, the rollers may apply different pressures to the user along the path. For example, the amount of pressure the rollers apply to the user may be based on the locations of the rollers on the path. The actuator(s) 118 may be configured to move the rollers in an up-and-down fashion (e.g., in the Y-direction), for example, into and out of the back, to apply different levels of pressure. The second carriage may therefore have two actuators, one that moves the second carriage along the track and one that moves the rollers.

In an embodiment, the amount of pressure applied by the rollers may be based on the preference(s) of the user, such as preference(s) stored in association with the profile 128. In an embodiment, the actuation of the actuator(s) 118 to control the pressure applied to the back of the user may be selected via the I/O component(s) 124, the remote 126, the mobile device 130 communicatively coupled to the myofascial mat 100, and so forth. Moreover, sensor(s) 120 may measure an amount of force applied by the rollers, for example, using load cell(s), toque sensor(s), resistance sensor(s), etc.

As will be explained herein, the myofascial mat 100 may include a lid 132 rotatably coupled to the base 102. A storage compartment may be located beneath the lid 132. The lid 132 may rotate between a closed position in which access to the storage compartment is restricted and an open position in which access to the storage compartment is permitted. The lid 132 is in the closed position in FIG. 1. In an embodiment, the lid 132 may correspond to a seating area of the myofascial mat 100. For example, in the closed position of the lid 132, a user may sit on top of the lid 132. Thereafter, the user may lay backward on the myofascial mat 100. A top of the lid may be padded, for example, with foam. In an embodiment, the cover 106 may be disposed over, stretched over, etc., the lid 132.

In an embodiment, the lid 132 may be secured in the closed position via a latch mechanism (e.g., lock, hook, etc.). For example, the latch mechanism may lock or otherwise secure the lid 132 in the closed position. However, the latch mechanism may be engaged, actuated, etc., to permit the lid 132 to transition to the open position. In an embodiment, sensor(s) 120 may detect a position of the lid 132, whether the latch mechanism is engaged, etc., for at least partially controlling an operation of the myofascial mat 100. For example, when the lid 132 is in the open position, the myofascial mat 100 may be restricted from operating, providing therapeutic relief to the user, etc. The actuator(s) 118 may be restricted from operating, moving the first carriage and the second carriage along the track, and so forth. Comparatively, when the lid 132 is in the closed position, the myofascial mat 100 may be permitted to operate and provide therapeutic relief. The sensor data 122 generated by the sensor(s) 120 may indicate the position of the lid 132. Example sensor(s) 120 used to determine the position of the lid 132 may include contact sensor(s), proximity sensor(s), Hall effect sensor(s), etc.

In an embodiment, the myofascial mat 100 may include heating element(s) 134 that provide heat therapy. In an embodiment, the heating element(s) 134 may be disposed within, beneath, into, etc., the cover 106 and/or the pieces of foam 104. The user may control an amount of heat, a location of the heat along the back, etc. provided by the heating element(s) 134. The amount of heat may be controlled via the I/O component(s) 124, the remote 126, the mobile device 130, etc. Moreover, preference(s) of the user, such as a location of the heat, an amount of heat, a time of applying heat, etc. may be stored in association with the profile 128.

The memory 116 is shown storing or having access to setting(s) 136. In an embodiment, the myofascial mat 100 may operate according to the setting(s) 136, for example, whereby the setting(s) 136 indicate a speed of the massager(s) and/or the roller(s), a pressure to be applied by the massager(s) and/or roller(s), a length of the track along which the second carriage traverses, heat applied via the heating element(s) 134, and so forth. The processor(s) 114 may be configured to carry out or perform the operations of the myofascial mat 100 in accordance with the setting(s) 136. The setting(s) 136 may be changed by the user or based upon preconfigured operations of the myofascial mat 100.

In an embodiment, the myofascial mat 100 may be battery-powered or mains powered. The myofascial mat 100 is shown being communicatively coupled to the mobile device 130 and/or remote computing resource(s) 138 via one or more networks, which may be representative of any type of network, whether wired or wireless (e.g., Wi-Fi, Cellular, Bluetooth, etc.). The myofascial mat 100 may include suitable network interface(s) to communicate over the network(s) 140. As indicated above, the mobile device 130 may be used to at least partially control an operation of the myofascial mat 100. Moreover, the mobile device 130 may operate an application that provides a history, usage, etc., of the myofascial mat 100.

In an embodiment, the remote computing resource(s) 138 may process sensor data 122 generated by the sensor(s) 120. For example, the sensor data 122 may be processed to determine the amount of pressure applied by the massager(s) and/or roller(s) for use in refining, updating, controlling, etc., operations performed by the myofascial mat 100. In an embodiment, the remote computing resource(s) 138 may be implemented as one or more servers and may, in an embodiment, form a portion of a network-accessible computing platform implemented as a computing infrastructure of processors, storage, software, data access, etc. that is maintained and accessible via a network such as the Internet. The remote computing resource(s) 138 does not require end-user knowledge of the physical location and configuration of the system that delivers the services. Common expressions associated with the remote computing resource(s) 148 may include “on-demand computing”, “software as a service (SaaS)”, “platform computing”, “network-accessible platform”, “cloud services”, “data centers”, etc.

As used herein, a processor, such as the processor(s) 114 may include multiple processors and/or a processor having multiple cores. Further, the processor(s) 114 may comprise one or more cores of different types. For example, the processor(s) 114 may include application processor units, graphic processing units, and so forth. In one implementation, the processor(s) 114 may comprise a microcontroller and/or a microprocessor. The processor(s) 114 may include a graphics processing unit (GPU), a microprocessor, a digital signal processor or other processing units or components known in the art. Alternatively, or in addition, the functionally described herein can be performed, at least in part, by one or more hardware logic components. For example, and without limitation, illustrative types of hardware logic components that may be used include field-programmable gate arrays (FPGAs), application-specific integrated circuits (ASICs), application-specific standard products (ASSPs), system-on-a-chip systems (SOCs), complex programmable logic devices (CPLDs), etc. Additionally, each of the processor(s) 114 may possess its own local memory, which also may store program components, program data, and/or one or more operating systems.

Memory, such as the memory 116 may include volatile and nonvolatile memory, removable and non-removable media implemented in any method or technology for storage of information, such as computer-readable instructions, data structures, program component, or other data. Such memory may include, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computing device. The memory may be implemented as computer-readable storage media (“CRSM”), which may be any available physical media accessible by the processor(s) to execute instructions stored on the memory. In one basic implementation, CRSM may include random access memory (“RAM”) and Flash memory. In other implementations, CRSM may include, but is not limited to, read-only memory (“ROM”), electrically erasable programmable read-only memory (“EEPROM”), or any other tangible medium which can be used to store the desired information and which can be accessed by the processor(s) 114. The memory 116 is an example of non-transitory computer-readable media. The memory 116 may store an operating system and one or more software applications, instructions, programs, and/or data to implement the methods described herein and the functions attributed to the various systems.

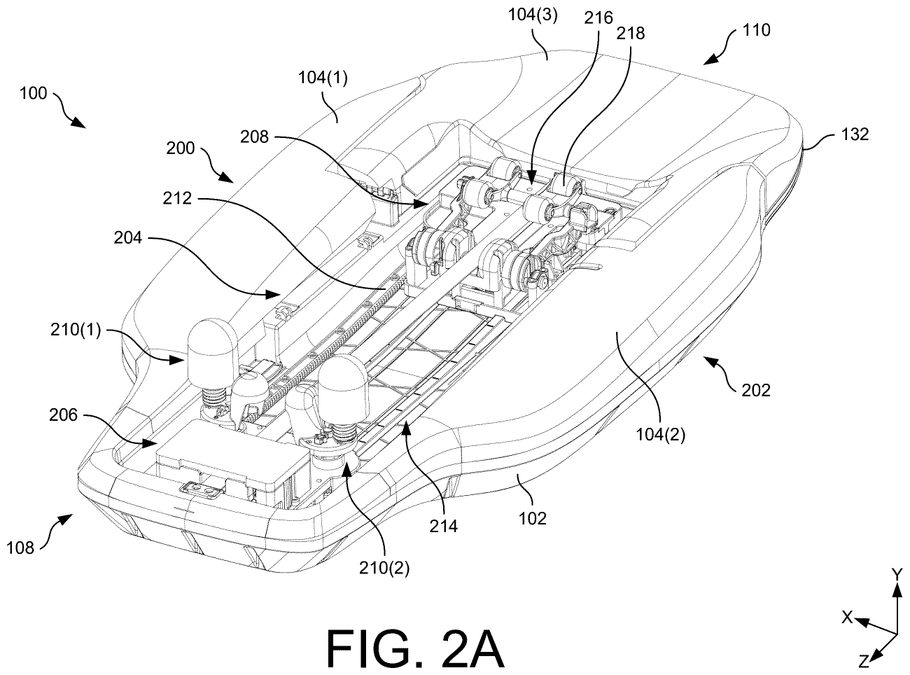

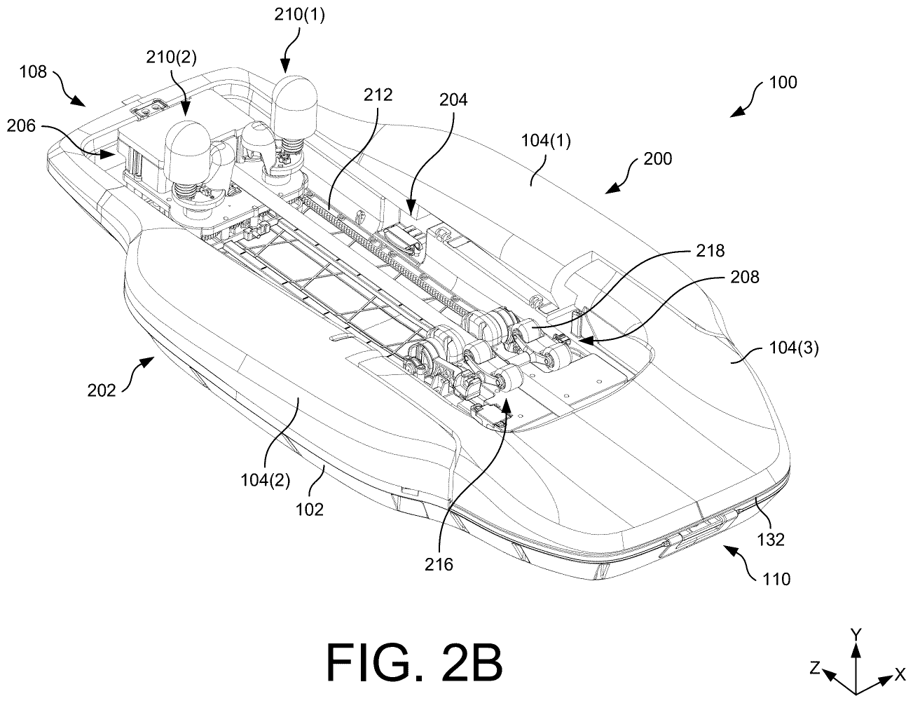

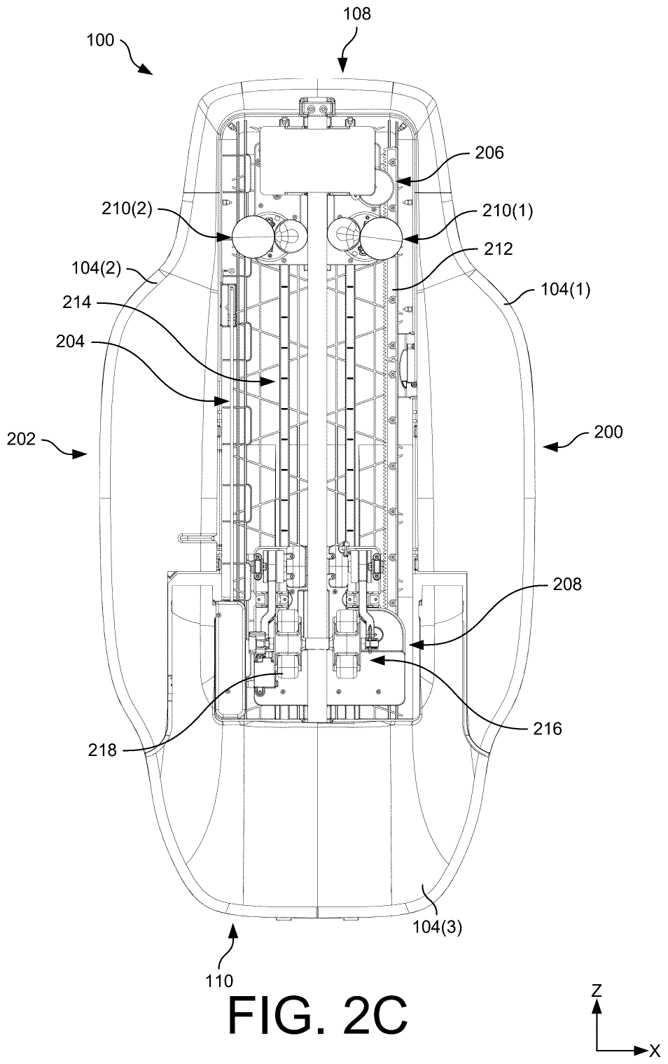

FIGS. 2A-2C illustrate the myofascial mat 100, showing the cover 106 removed, according to examples of the present disclosure. FIG. 2A illustrates a first isometric view of the myofascial mat 100 (e.g., from the first end 108), FIG. 2B illustrates a second isometric view of the myofascial mat 100 (e.g., from the second end 110), and FIG. 2C illustrates a top planar view of the myofascial mat 100.

As introduced above, the myofascial mat 100 may include the base 102 to which components of the myofascial mat 100 couple. In an embodiment, the pieces of foam 104 include at least a first piece of foam 104(1) and a second piece of foam 104(2). The first piece of foam 104(1) may be coupled to the base 102 along a first side 200 of the myofascial mat 100 and the second piece of foam 104(2) may be coupled to the base 102 along a second side 202 of the myofascial mat 100. Portions of the first piece of foam 104(1) and the second piece of foam 104(2) may also extend along the first end 108 of the myofascial mat 100. The lid 132 may be coupled to the base 102 and disposed proximate to the second end 110. The lid 132 may include a third piece of foam 104(3). The cover 106, however, may be disposed over the pieces of foam 104.

The pieces of foam 104 may include a thickness (e.g., in Y-direction). When the user lays on the myofascial mat 100, the user may lay adjacent to a top surface of the pieces of foam 104. For example, the user may initially rest (e.g., sit) on the third piece of foam 104(3) and lay backward towards the first end 108. A left side of the back of the user may rest on a top surface of the first piece of foam 104(1) and a right side of the back of the user may rest on a top surface of the second piece of foam 104(2). A portion of the back of the user may span between the first piece of foam 104(1) and the second piece of foam 104(2). In other words, the spine may lie between the first piece of foam 104(1) and the second piece of foam 104(2).

The myofascial mat 100 may include an internal compartment 204 (e.g., cavity, chamber, hollow area, etc.) in which a first carriage 206 and a second carriage 208 reside. In an embodiment, the internal compartment 204 may be defined by the base 102 (e.g., along a bottom) and the pieces of foam 104 (e.g., along sides, ends, etc.). When the cover 106 couples to the myofascial mat 100, the cover 106 may be disposed over the first carriage 206 and the second carriage 208. Although described as carriages, the first carriage 206 and/or the second carriage 208 may represent assemblies, sub-assemblies, etc., of the myofascial mat 100 that are configured to move or be positioned at different locations within the internal compartment 204. Moreover, as will be discussed herein, other internal components of the myofascial mat 100, such as the sensor(s) 120, batteries, computing components (e.g., the processor(s) 114, memory 116, PCBs, etc.), etc., may be disposed within the internal compartment 204.

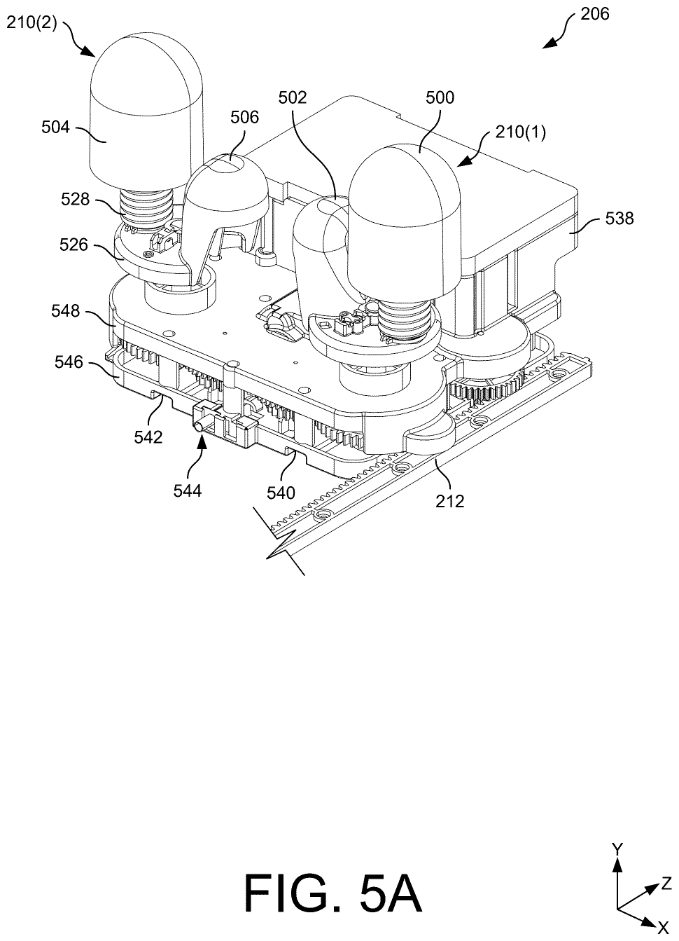

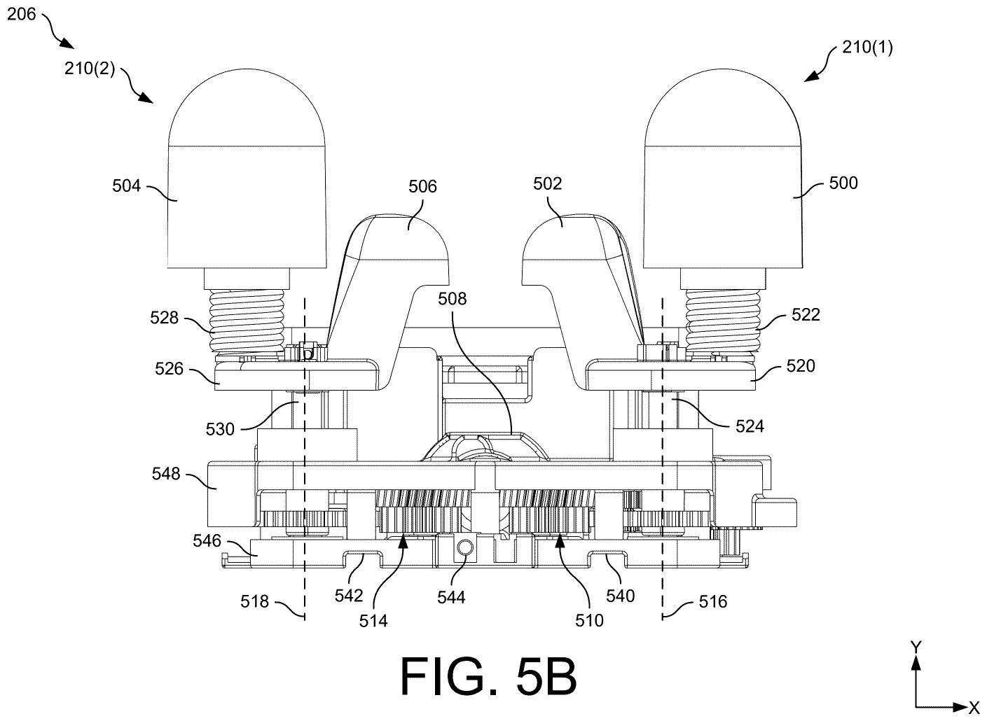

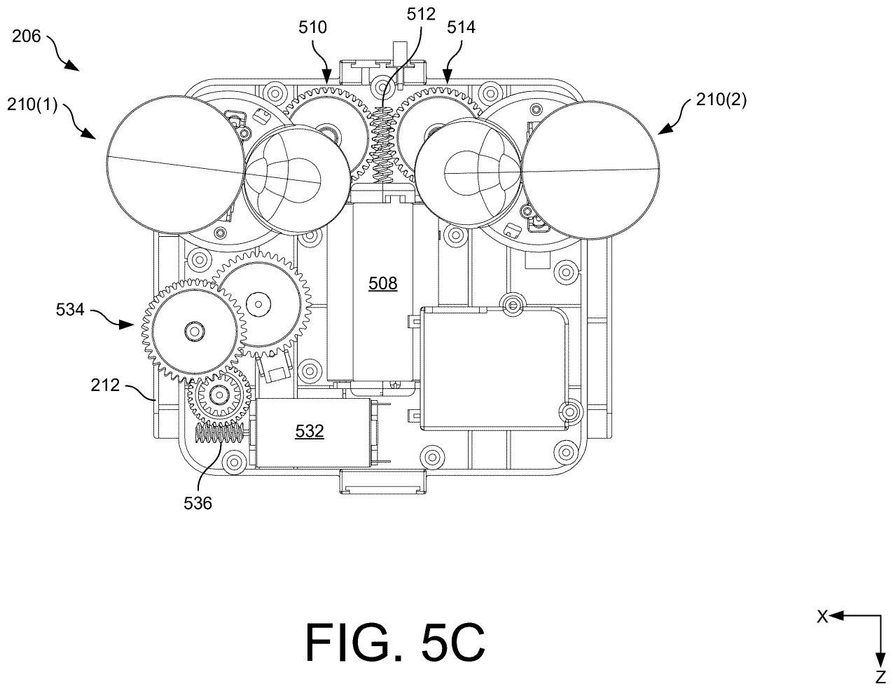

As introduced above with regard to FIG. 1, the first carriage 206 may include massagers 210 that provide therapeutic relief to the user, such as their neck. The massagers 210 may form the head rest location 112 of the myofascial mat 100. In an embodiment, the massagers 210 may include a first massager 210(1) and a second massager 210(2). The massagers 210 may represent nodes, nodules, myofascial features, knob, etc., that are actuatable to massage the neck, upper back, or areas around the neck. For example, the massagers 210 may rotate (e.g., about the Y-axis) to provide therapeutic relief. Additional details of the massagers 210 are discussed herein with regard to FIGS. 5A-5C.

The massagers 210 move with the first carriage 206 as the first carriage 206 moves in a direction between the first end 108 and the second end 110 (e.g., in the Z-direction). For example, the actuator(s) 118 may engage with a gear rack 212 via one or more gears of the first carriage 206. The gear rack 212 may be coupled to the base 102. As the actuator(s) 118 rotate, the first carriage 206 may be driven along a track 214 of the myofascial mat 100. In doing so, the massagers 210 may be moved into position adjacent to the neck. The positioning of the massagers 210 along the track 214 permits the myofascial mat 100 to accommodate different users (e.g., users of different heights). That is, the massagers 210 may be located at different positions along the track 214 based on the height of the user. As will be discussed herein, the track 214 may include a first rail and a second rail along which the first carriage 206 and the second carriage 208 move.

The user may interact with the I/O component(s) 124, the remote 126, the mobile device 130, etc., to move the first carriage 206 along the track 214 and into position adjacent to the neck. Moreover, the location of the first carriage 206 may be based on preference(s) stored in association with the profile 128. Additionally, in an embodiment, sensor data 122 generated by the sensor(s) 120 may be used to position the first carriage 206. For example, the sensor(s) 120 may be used to sense a position, placement, etc., of the user along the myofascial mat 100 and then position the first carriage 206 (or the massagers 210) accordingly. In one example, when the user lays on the myofascial mat 100, the first carriage 206 may move along the track 214 until the massagers 210 are in position adjacent to the neck. In another embodiment, the sensor(s) 120 may detect where, how, etc., the user is lying on the myofascial mat 100. The sensor(s) 120 may include contact sensor(s), resistive sensor(s), capacitive sensor(s), limit switches, proximity sensor(s), etc.

The second carriage 208 is configured to move along the track 214 via actuator(s) 118 that engage the gear rack 212 via one or more gears of the second carriage 208. As the actuator(s) 118 rotate and engage the gear rack 212, the second carriage 208 may be driven along the track 214 (e.g., in the Z-direction). The second carriage 208 may include a roller assembly 216 having rollers 218 that engage the back, for example, on opposing sides of the spine. In an embodiment, the second carriage 208 may move along the track 214 to provide therapeutic relief to different portions of the back. For example, while the first carriage 206 may remain stationary along the track 214, once in position adjacent to the neck, the second carriage 208 may move along a length of the track 214. As the second carriage 208 moves along the track 214 the rollers 218 may provide therapeutic relief between the thoracic region of the spine and the lumbar region of the spine, for example.

In an embodiment, the length of the track 214 over which the second carriage 208 is configured to move may be based at least in part on the location of the first carriage 206 on the track 214. For example, once the first carriage 206 is positioned adjacent to the neck, the second carriage 208 may move between an end of the track 214 proximate to the lid 132 and adjacent to the first carriage 206. The second carriage 208, however, may not contact the first carriage 206. The first carriage 206 may limit a length of the track 214 over which the second carriage 208 is configured to move. As the second carriage 208 moves along the track 214 the rollers 218 may apply pressure against the back. In an embodiment, and as will be discussed herein, the actuator(s) 118 may adjust an amount of pressure the rollers 218 apply or press against the back.

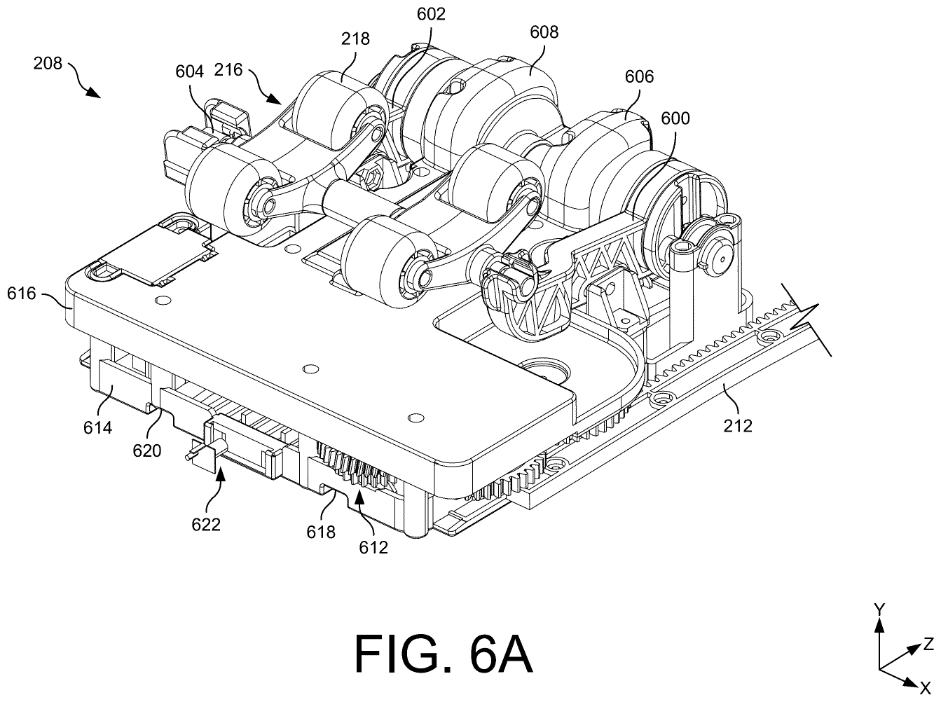

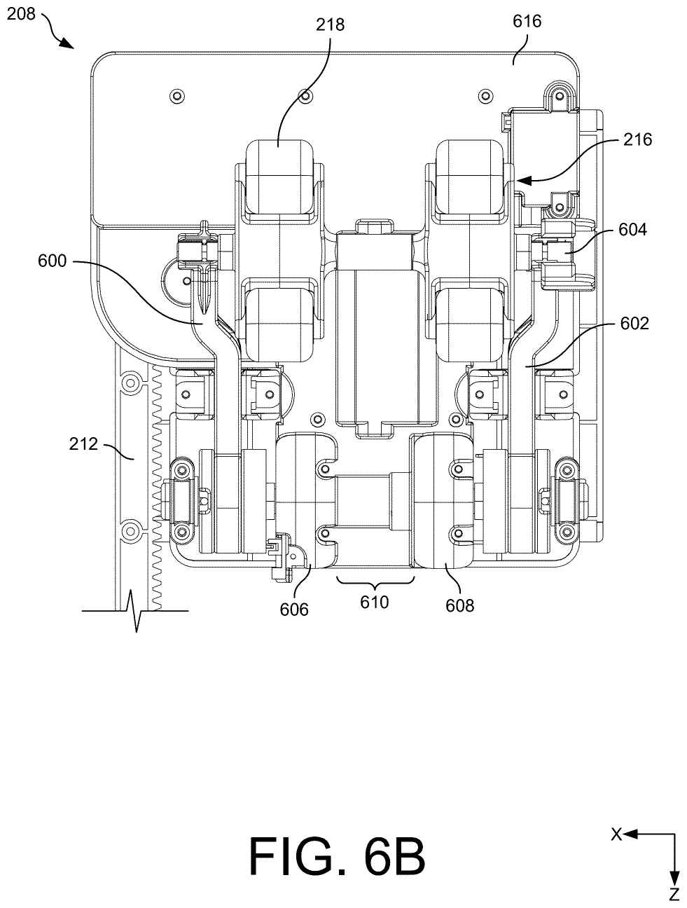

As shown, the roller assembly 216 may include four of the rollers 218. However, as will be explained herein, other rollers or roller assemblies may be interchanged with the roller assembly 216 and/or the rollers 218 as shown in FIGS. 2A-2C. Additional details of the roller assembly 216 and the rollers 218 are discussed in FIGS. 6A-14.

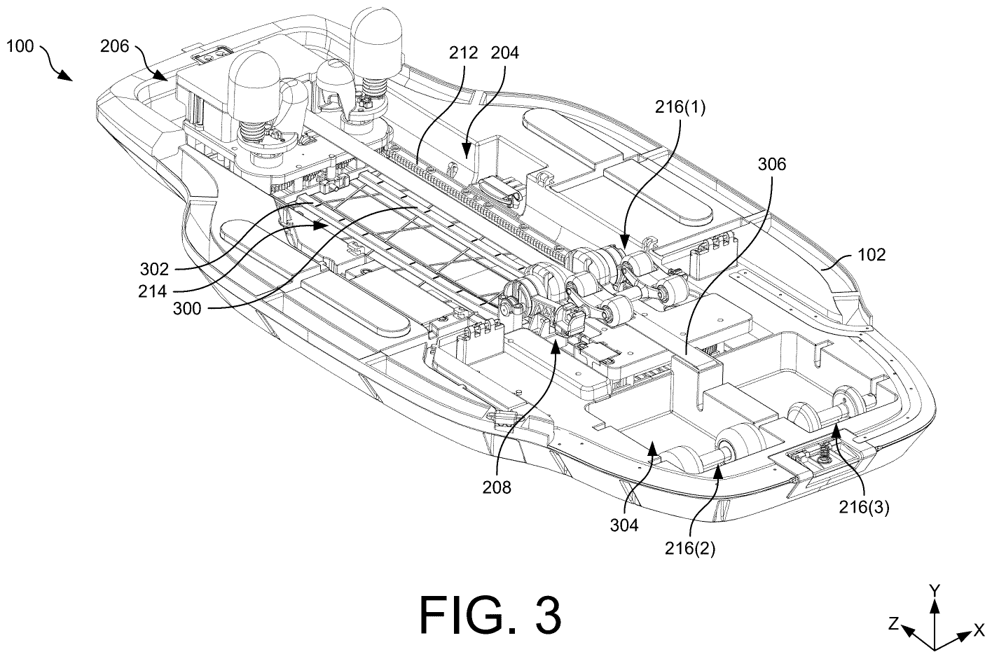

FIG. 3 illustrates a perspective view of the myofascial mat 100, showing the pieces of foam 104 and the lid 132 removed, according to examples of the present disclosure. As introduced above, the first carriage 206 and the second carriage 208 are configured to move along the track 214. In an embodiment, the track 214 may include a first rail 300 and a second rail 302 coupled to the base 102. The first carriage 206 and the second carriage 208 may slide along, over, etc., the first rail 300 and the second rail 302 to maintain an orientation within the myofascial mat 100. Moreover, the actuator(s) 118 of the first carriage 206 and the second carriage 208 may engage the gear rack 212 via one or more gear(s) to move the first carriage 206 and the second carriage 208 along the track 214.

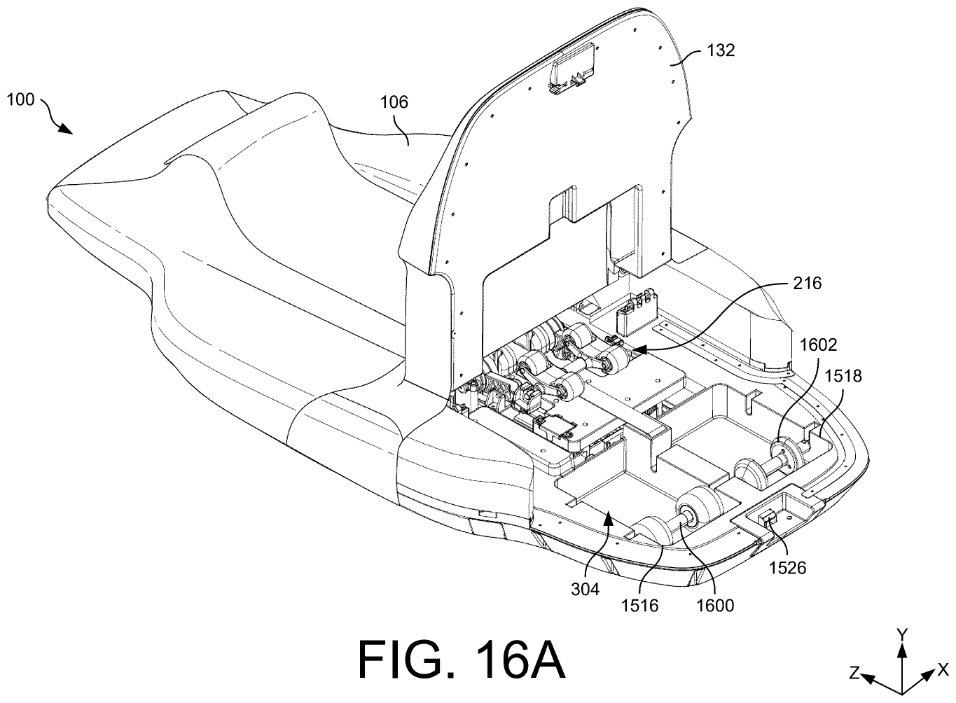

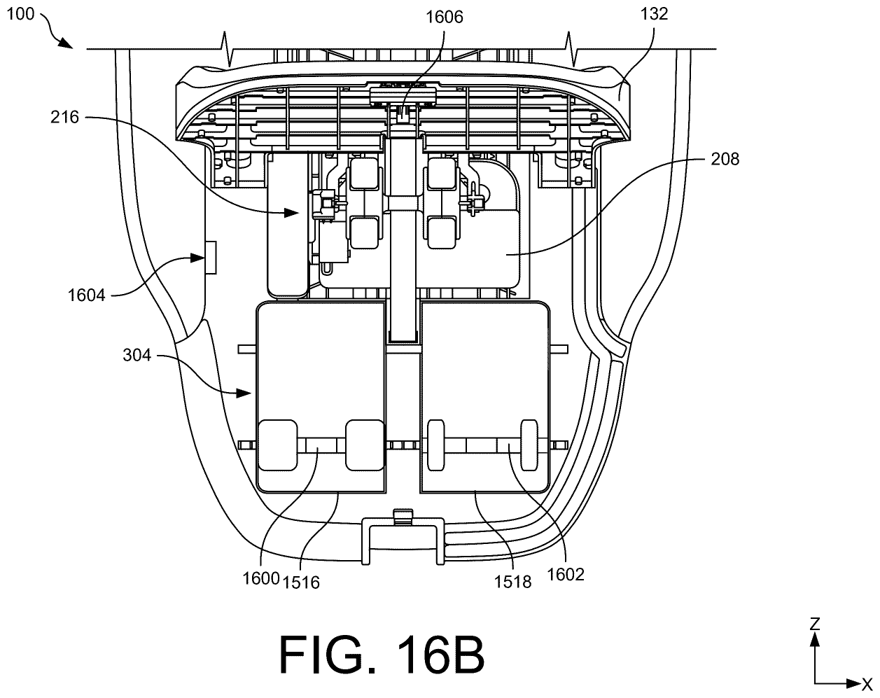

The base 102 may define a storage compartment 304 that receives roller assemblies. For example, as will be explained with regard to FIGS. 16A and 16B, the lid 132 may be opened to access the storage compartment 304. Different roller assemblies may be configured to couple to the second carriage 208 to provide different therapeutic relief. For example, the rollers of the different roller assemblies may be differently shaped or sized, may have different surface finishes, durometers, may have a different number of rollers, etc. For example, a first roller assembly 216(1) may be coupled to the second carriage 208, while a second roller assembly 216(2) and a third roller assembly 216(3) may be stored in the storage compartment 304. The base 102 may at least partially define the storage compartment 304.

In an embodiment, a strap 306 may be disposed at least partially over, across, etc. the internal compartment 204. The strap 306 may assist in supporting a weight of the user once the user lays on the myofascial mat 100. The cover 106, the pieces of foam 104, the first carriage 206, and the second carriage 208 may additionally support the weight of the user. However, the strap 306 may prevent the user from sinking, sagging, dropping, etc., into the internal compartment 204. In an embodiment, the strap 306 may extend between the first carriage 206 and the storage compartment 304. The strap 306 may be elastic in nature. However, in an embodiment, the strap 306 may be static in nature and not configured to stretch.

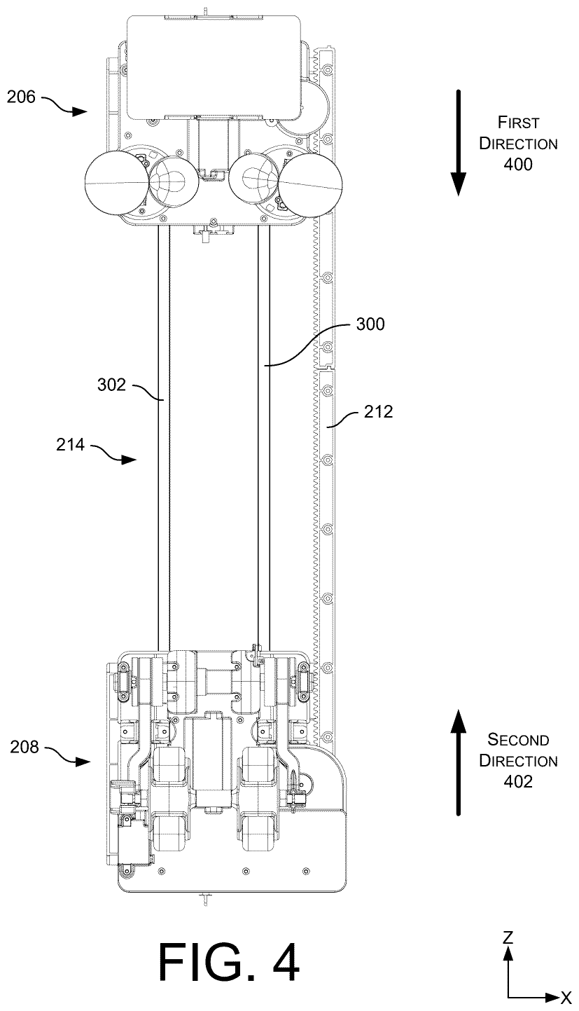

FIG. 4 illustrates the first carriage 206, the second carriage 208, the track 214, and the gear rack 212, according to examples of the present disclosure. The first carriage 206 and the second carriage 208 are configured to move along the track 214, such as the first rail 300 and the second rail 302, when gears of the first carriage 206 and the second carriage 208 are driven along the gear rack 212. For example, as will be explained herein, actuator(s) 118 of the first carriage 206 and the second carriage 208 may rotate gears, respectively, that are engaged with the gear rack 212 to move the first carriage 206 and the second carriage 208 along the track 214.

The gear rack 212, the first rail 300, and/or the second rail 302 may be continuous pieces of material coupled to the base 102. Alternatively, in an embodiment, the gear rack 212, the first rail 300, and/or the second rail 302 may be formed via multiple sections, segments, etc., coupled together.

The first carriage 206 may move in a first direction 400, away from the first end 108 of the myofascial mat 100 or towards the second end 110 of the myofascial mat 100, to dispose the first massager 210(1) and the second massager 210(2) adjacent to the neck. For example, after the user lays on the myofascial mat 100, the first carriage 206 may move in the first direction 400. The movement of the first carriage 206 in the first direction 400 may come by way of the I/O component(s) 124, the mobile device 130, the remote 126, or the sensor(s) 120 sensing a position of the massagers 210 (or the first carriage 206) adjacent to the neck. As such, the myofascial mat 100 may accommodate users with different characteristics (e.g., height, weight, shape, etc.).

With the massagers 210 in place adjacent to the neck, the second carriage 208 may be configured to move along a remaining length of the track 214. For example, the second carriage 208 may move between an end of the track 214 and the first carriage 206, in a second direction 402 that is opposite the first direction 400. As the second carriage 208 moves in the second direction 402, and the rollers 218 engage the back of the user, the second carriage 208 may approach the first carriage 206. The first carriage 206 may remain stationary, so as to not move along the track 214 and remain in position adjacent to the neck. The second carriage 208 may reverse course upon reaching, contacting, etc., the first carriage 206 and move in the first direction 400, away from the first carriage 206. Upon reaching an end of the track 214 after traveling in the first direction 400, the second carriage 208 may reverse course and move once again in the second direction 402. This process may repeat as the second carriage 208 moves up and down, back and forth, etc. along the track 214 (e.g., in the Z-direction).

The length of the track 214 along which the second carriage 208 traverses may be based on the location of the first carriage 206 on the track 214. For example, for taller users, the length of the track 214 along which the second carriage 208 moves may be longer in length than for shorter users. That is, for taller users, given that the first carriage 206 may not move as much in the first direction 400 to position the massagers 210 adjacent to the neck, the length of the track 214 along which the second carriage 208 moves may be longer than for shorter users. The second carriage 208 may be permitted to move a longer length in the second direction 402 before reversing course and moving in the second direction 402. The location of the first carriage 206 on the track 214, when positioned adjacent to the neck, is therefore used to determine a length of the track 214 along which the second carriage 208 moves.

The first carriage 206 and the second carriage 208 may therefore move along the track 214, however, the first carriage 206 may limit a length of the track 214 that the second carriage 208 traverses. In an embodiment, the second carriage 208 may move along a portion of the length of the track 214 between the first carriage 206 and an end of the track 214 (e.g., adjacent to the second end 110), or an entirety of the length between the first carriage 206 and the end of the track. In an embodiment, the length of the track 214 along which the second carriage 208 traverses may be based on preference(s) of the user, for example, as stored in the profile 128. For example, the user may prefer to have the second carriage 208 remain stationary on the track 214 to provide therapeutic relief to a particular portion of the back (e.g., lumbar), or to translate along a specific portion of the track 214, etc. During this instance, the rollers 218 may move into and out of the back of the user (e.g., in a circular fashion). In other instances, the rollers 218 may move while the second carriage 208 moves along the track 214.

FIGS. 5A-5C illustrate the first carriage 206 of the myofascial mat 100, according to examples of the present disclosure. FIG. 5A illustrates an isometric view of the first carriage 206, FIG. 5B illustrates a side view of the first carriage 206, and FIG. 5C illustrates a top view of the first carriage 206.

The first carriage 206, as introduced above, includes the first massager 210(1) and the second massager 210(2). The first massager 210(1) and the second massager 210(2) may be dynamic moving massagers. In an embodiment, the first massager 210(1) includes a first node 500 and a second node 502 that massage the user. The first node 500 and the second node 502 may be considered myofascial features (e.g., knobs, nodules, fingers, etc.) that engage the neck or around the neck to provide therapeutic relief. As shown, the first node 500 may be taller (e.g., in the Y-direction) to engage along the sides of the neck, while the second node 502 may engage along the back of the neck, for example.

Similarly, in an embodiment, the second massager 210(2) includes a first node 504 and a second node 506 that massage the user. The first node 504 and the second node 506 may be considered myofascial features (e.g., knobs, nodules, fingers, etc.) that engage the neck or around the neck. As shown, the first node 504 may be taller (e.g., in the Y-direction) to engage along the sides of the neck, while the second node 506 may engage along the back of the neck, for example. The first massager 210(1) may massage a left side of the neck while the second massager 210(2) may massage a right side of the neck.

A first actuator 508 may actuate or power the first massager 210(1) and the second massager 210(2). One or more first gears 510 may engage with a worm gear 512 of the first actuator 508 to transfer motion to the first massager 210(1). Likewise, one or more second gears 514 may engage with the worm gear 512 to transfer motion to the second massager 210(2). The first gears 510 and the second gears 514 may represent any suitable gears (e.g., helical, spur, worm, etc.). Any number of the first gears 510 and the second gears 514 may be used, for example, to adjust speed, torque, etc.

In an embodiment, the first massager 210(1) and the second massager 210(2) may be actuated in unison, or only one of the first massager 210(1) or the second massager 210(2) may be actuated at a time. The first massager 210(1) may rotate around a first axis of rotation 516. The second massager 210(2) may rotate around a second axis of rotation 518. In an embodiment, the first massager 210(1) may rotate completely (e.g., 360 degrees) around the first axis of rotation 516 and/or the second massager 210(2) may rotate completely (e.g., 360 degrees) around the second axis of rotation 518. However, the first massager 210(1) and the second massager 210(2) may rotate around less than an entirety of the first axis of rotation 516 and the second axis of rotation 518, respectively.

In an embodiment, the first massager 210(1) and/or the second massager 210(2) may move in both clockwise and/or counterclockwise directions about the first axis of rotation 516 and the second axis of rotation 518, respectively. For example, the first massager 210(1) may rotate clockwise about the first axis of rotation 516 for a predetermined distance, angle, etc., such as ninety degrees, and may then rotate counterclockwise about the first axis of rotation 516. In this manner, the first massager 210(1) may move back and forth about the first axis of rotation 516 in the clockwise and the counterclockwise direction. Similarly, the second massager 210(2) may rotate counterclockwise about the second axis of rotation 518 for a predetermined distance, angle, etc., such as ninety degrees, and may then rotate clockwise about the second axis of rotation 518. In this manner, the second massager 210(2) may move back and forth about the second axis of rotation 518 in the counterclockwise and the clockwise direction. Movement of the first massager 210(1) and the second massager 210(2), or their rotational direction, maybe controlled via the first actuator 508.

The first massager 210(1) may include a platform 520 to which the first node 500 and the second node 502 couple or extend from. In an embodiment, a biasing element 522 may extend between the platform 520 and the first node 500, such that the first node 504 is biased into contact with the neck. Moreover, an axle 524 may couple the first massager 210(1) to the one or more first gears 510. The second massager 210(2) may include a platform 526 to which the first node 504 and the second node 506 couple or extend from. In an embodiment, a biasing element 528 may extend between platform 526 and the first node 504, such that the first node 504 is biased into contact with the neck. Moreover, an axle 530 may couple the second massager 210(2) to the one or more second gears 514.

The first carriage 206 may include a second actuator 532 that is configured to move the first carriage 206 along the first rail 300 and the second rail 302 of the track 214. For example, the first carriage 206 may include one or more third gears 534 that engage with a worm gear 536 of the second actuator 532. During rotation of the second actuator 532, motion is imparted to the one or more third gears 534 via the worm gear 536. One of the one or more third gears 534 engages with the gear rack 212 to move the first carriage 206 along the first rail 300 and the second rail 302. The second actuator 532 may rotate in clockwise or counterclockwise directions to move the first carriage 206 in the first direction 400 and the second direction 402.

The first actuator 508, the second actuator 532, the one or more first gears 510, the one or more second gears 514, the one or more third gears 534, etc. of the first carriage 206 may be disposed within, couple to, mount to, etc. housings, covers, etc. of the first carriage 206. For example, the first carriage 206 may include a housing 538 in which computing components reside. The computing components may control an operation of the first carriage 206. The first carriage 206 may also include a first cover 546 and a second cover 548. The one or more first gears 510, the one or more second gears 514, the one or more third gears 534 may at least partially disposed, mounted about, etc. the first cover 546 and/or the second cover 548. The first actuator 508 and the second actuator 532 may also be disposed between the first cover 546 and the second cover 548. In FIG. 5C, the housing 538 and the second cover 548 are shown removed to illustrate the first actuator 508, the second actuator 532, the one or more first gears 510, the one or more second gears 514, the one or more third gears 534, etc.

In an embodiment, the first cover 546 defines a first groove 540 and a second groove 542 that receive the first rail 300 and the second rail 302, respectively. The first groove 540 and the second groove 542 may represent channels, passages, etc., formed in the first cover 546. As the first carriage 206 moves in the first direction 400 and the second direction 402, the first rail 300 may slide within the first groove 540 and the second rail 302 may slide within the second groove 542. An engagement between the first groove 540 and the second groove 542 with the first rail 300 and the second rail 302, respectively, may maintain an orientation of the first carriage 206 within the myofascial mat 100. In an embodiment, wheels, bears, bushings, etc., may engage the first rail 300 and/or the second rail 302 to reduce friction.

In an embodiment, the first carriage 206 includes a sensor 544 disposed on the first cover 546. The sensor 544 may represent a contact sensor, limit switch, proximity sensor, etc., that senses the presence of the second carriage 208. For example, when the second carriage 208 moves in the second direction 402, a frame, housing, etc. of the second carriage 208 may contact the sensor 544 (or a prong, bar, spring, etc. of the sensor 544). When contact is sensed, the second carriage 208 may reverse direction, moving in the second direction 402, to avoid further movement in the first direction 400. Computing components of the first carriage 206 (e.g., within the housing 538) may communicatively couple to computing components of the second carriage 208, or other computing components of the myofascial mat 100 to control such movement.

FIGS. 6A and 6B illustrate the second carriage 208, according to examples of the present disclosure. FIG. 6A illustrates an isometric view of the second carriage 208 and FIG. 6B illustrates a top planar view of the second carriage 208.

The second carriage 208, as introduced above, includes the roller assembly 216 having the rollers 218. As shown, the roller assembly 216 may include four of the rollers 218, where a first subset, portion, etc. of the rollers 218 may massage a first side of the back of the user (e.g., left side), and a second subset, portion, etc. of the rollers 218 may massage a second side of the back of the user (e.g., right side). The roller assembly 216 may couple to a first arm 600 and a second arm 602. As will be explained herein, the first arm 600 and the second arm 602 may raise and lower the roller assembly 216 (e.g., in the Y-direction) such that the rollers 218 impart different amounts of pressure to the user. In an embodiment, the first arm 600 and the second arm 602 may represent cantilevered arms that raise and lower the roller assembly 216 into and out of the back.

In an embodiment, the first arm 600 and the second arm 602 may be capable of raising the lowering the roller assembly 216 between a bottom-most position and a top-most position. In an embodiment, a distance between the top-most position and the bottom-most position may be 10 millimeters, 30 millimeters, etc. Other distances, however, are envisioned. The sensor(s) 120 may be used to measure or determine a position of the roller assembly 216, an amount of pressure applied by the rollers 218, etc., to determine whether the roller assembly 216 may be further raised or lowered. As will be explained herein, the roller assembly 216 may include an axle 604 that is received within receptacles, sockets, etc., of the first arm 600 and the second arm 602.

The first carriage 206 may also include a first protrusion 606 and a second protrusion 608. The first protrusion 606 and the second protrusion 608 may engage a back of the user, through the cover 106. The first protrusion 606 and the second protrusion 608 may not be configured to move in an up-and-down fashion, as the roller assembly 216, but may move with the second carriage 208. A distance 610 disposed between the first protrusion 606 and the second protrusion 608 may accommodate the spine of the user, such that the spine resides between the first protrusion 606 and the second protrusion 608. As such, the first protrusion 606 may provide therapeutic relief along a first side of the spine (e.g., left side) while the second protrusion 608 may provide therapeutic relief along a second side of the spine (e.g., right side). The first protrusion 606 and the second protrusion 608 may be considered myofascial features (e.g., nodes, nodules, fingers, etc.). The first protrusion 606 and the second protrusion 608 may be considered passive massagers in that the first protrusion 606 and the second protrusion 608 are not powered.

The second carriage 208 includes an actuator (obscured in FIGS. 6A and 6B) that move the second carriage 208 along the first rail 300 and the second rail 302 of the track 214. For example, the second carriage 208 may include one or more first gears 612 that engage with the actuator. During rotation of the actuator, motion is imparted to the one or more first gears 612 and the one of the one or more first gears 612 engages with the gear rack 212 to move the second carriage 208 along the first rail 300 and the second rail 302. Any number of the one or more first gears 612 may be used to adjust speed, torque, etc.

The second carriage 208 may also include a first cover 614 and a second cover 616 between which the one or more first gears 612, and other components of the second carriage 208, such as the actuators, reside. In an embodiment, the first cover 614 defines a first groove 618 and a second groove 620 that receive the first rail 300 and the second rail 302, respectively. The first groove 618 and the second groove 620 may represent channels, passages, etc., formed in the first cover 614. As the second carriage 208 moves along the track 214, the first rail 300 may slide within the first groove 618 and the second rail 302 may slide within the second groove 620. An engagement between the first groove 618 and the second groove 620 with the first rail 300 and the second rail 302, respectively, may maintain an orientation of the second carriage 208 within the myofascial mat 100. In an embodiment, wheels, bears, bushings, etc., may engage the first rail 300 and/or the second rail 302 to reduce friction.

In an embodiment, the second carriage 208 includes a sensor 622 disposed on the first cover 614. The sensor 622 may represent a contact sensor, limit switch, proximity sensor, etc., that is used to determine when the second carriage 208 has fully moved in the first direction 400. For example, when the second carriage 208 moves in the first direction 400, the sensor 622 (or a prong, bar, etc. of the sensor 622) may contact features of the base 102, etc. When contact is sensed, the second carriage 208 may reverse direction, moving in the second direction 402, to avoid further movement in the first direction 400. As such, the sensor 622 may be used to determine when the second carriage 208 has moved in the first direction 400 to an end of the track 214, the gear rack 212, etc. Computing components of the second carriage 208, the first carriage 206, and/or other computing components disposed about the myofascial mat 100 may control such movement.

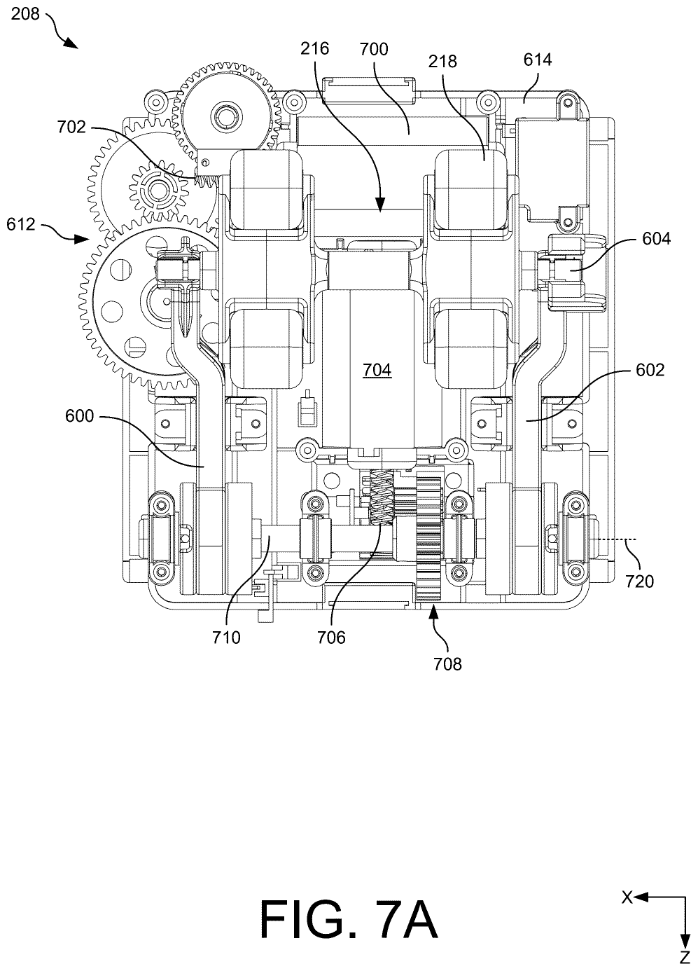

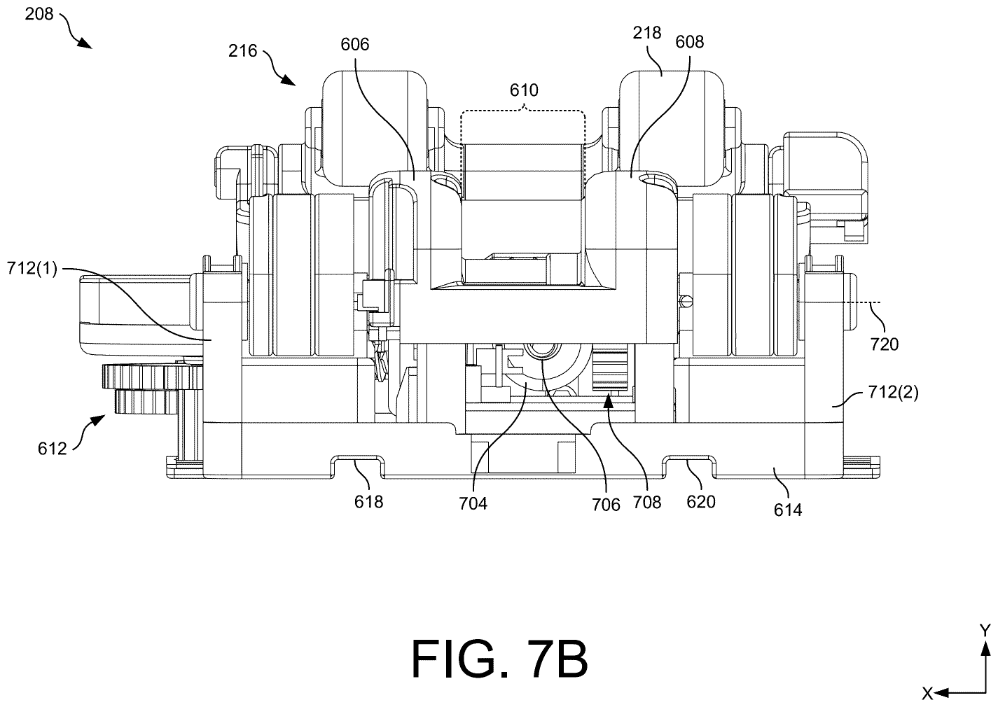

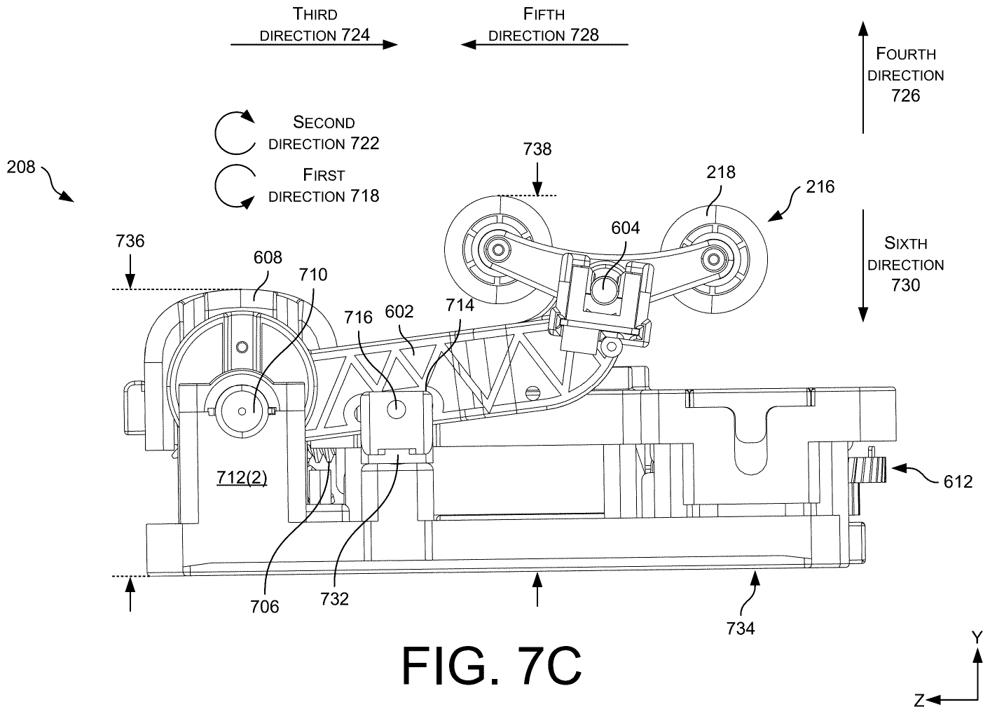

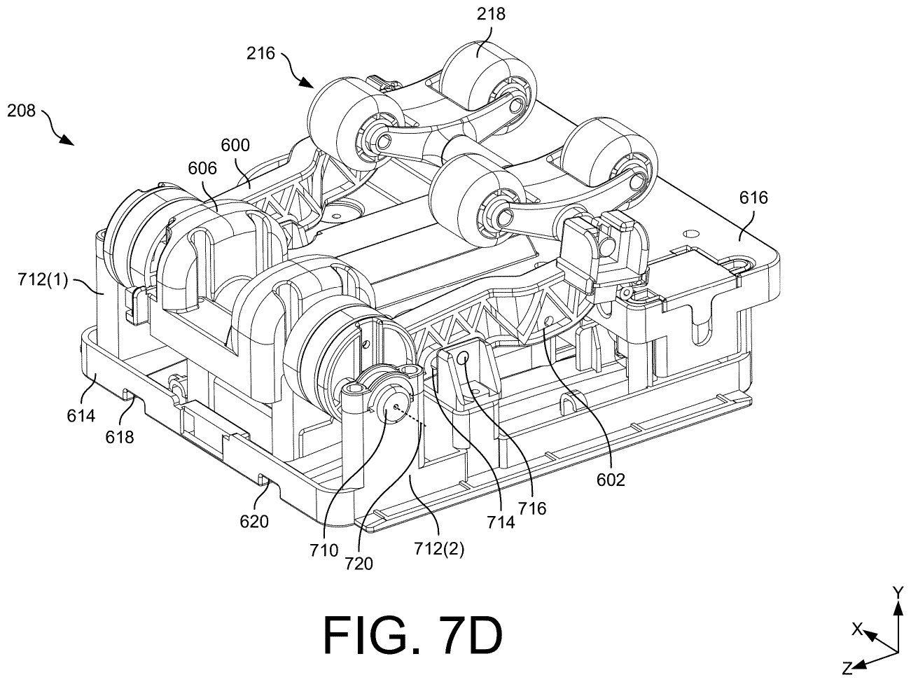

FIGS. 7A-7D illustrate details of the second carriage 208, according to examples of the present disclosure. FIG. 7A illustrates a planar top view of the second carriage 208, showing the second cover 616 removed, FIG. 7B illustrates an end view of the second carriage 208, FIG. 7C illustrates a side view of the second carriage 208, and FIG. 7D illustrates an isometric view of the second carriage 208.

The second carriage 208 includes a first actuator 700 that is configured to move the second carriage 208 along the first rail 300 and the second rail 302. For example, the first actuator 700 may include a worm gear 702 that engages the one or more first gears 612. During actuation of the first actuator 700 motion is imparted to the one or more first gears 612 via the worm gear 702. Therein, at least one of the one or more first gears 612 engages with the gear rack 212 to move the second carriage 208 along the first rail 300 and the second rail 302. The first actuator 700 may rotate in clockwise or counterclockwise directions to move the second carriage 208 in the first direction 400 and the second direction 402, respectively.

The second carriage 208 further includes a second actuator 704 that imparts motion to the first arm 600 and the second arm 602, for example, to apply different amounts of pressure to the user. For example, the second actuator 704 may rotate a worm gear 706 that is, in turn, engaged with one or more second gears 708 of the second carriage 208. The one or more second gears 708 may be engaged with a shaft 710 to which the first arm 600 and the second arm 602 are coupled. When motion is imparted to the shaft 710, via rotation of the one or more second gears 708, the first arm 600 and the second arm 602 may be caused to raise and lower (e.g., in the Y-direction) the roller assembly 216 to apply different amounts of pressure.

The shaft 710 may be mounted about one or more posts 712, such as a first post 712(1) and a second post 712(2). The shaft 710 may couple to the posts 712 about bearings, bushings, etc. The second arm 602 may include a slot 714 in which a pin 716 is disposed. The first arm 600 may also include a slot in which a pin is disposed. During rotation of the shaft 710, the pin 716 may translate between ends of the slot 714. The engagement between the slot 714 and the pin 716 may secure the first arm 600 to the second carriage 208. A similar engagement between another slot and another pin may secure the second arm 602 to the second carriage 208. For example, as the shaft 710 rotates in a first direction 718 about a axis of rotation 720 that extends through the shaft 710, such as in a counterclockwise direction, the pin 716 may move towards a first end of the slot 714, causing the roller assembly 216 to raise and apply an increased amount of pressure. As the shaft 710 rotates in a second direction 722 about the axis of rotation 720, such as in a clockwise direction, the pin 716 may move towards a second end of the slot 714, causing the roller assembly 216 to lower and apply a decreased amount of pressure.

The first arm 600 and the second arm 602 may not be concentrically mounted or coupled to the shaft 710. As such, during rotation of the shaft 710, the first arm 600 and the second arm 602 may urge the roller assembly 216 in an upward or downward direction to apply different amounts of pressure to the user. Given the nonconcentric mounting, as the shaft 710 is rotated, the coupling of the first arm 600 and the second arm 602 may have the effect of pushing and pulling the roller assembly 216 and, in turn, raising and lowering the roller assembly 216. For example, when the shaft 710 rotates in the first direction 718 about the axis of rotation 720, the first arm 600 and the second arm 602 may be pushed in a third direction 724. The shape of the slot 714 and the engagement between the pin 716 and the slot 714 may cause the roller assembly 216 to move in a fourth direction 726, thereby applying increased pressure to the user. Conversely, when the shaft 710 rotates in the second direction 722 about the axis of rotation 720, the first arm 600 and the second arm 602 may be pulled in a fifth direction 728 that is opposite the third direction 724. The shape of the slot 714 and the engagement between the pin 716 and the slot 714 may cause the roller assembly 216 to move in a sixth direction 730 that is opposite the fourth direction 726, thereby applying decreased pressure to the user.

In an embodiment, the shaft 710 may rotate predetermined distances in the first direction 718, and the second direction 722, as limited by an engagement between the pin 716 and ends of the slot 714, respectively. Sensor(s) 120 may be used to sense to position of the first arm 600 and the second arm 602, or the pin 716 within the slot 714, for determining whether and/or how much the roller assembly 216 may be further raised or lowered. As will be discussed herein, the roller assembly 216 mounts to the first arm 600 and the second arm 602 via the axle 604 and is configured to rotate about such coupling to conform to the user.

In an embodiment, the second carriage 208 may include a bracket 732 having a through hole through which the pin 716 is disposed. The bracket 732 may be disposed on either or both sides of the first arm 600 and the second arm 602, respectively, and may be coupled to the second cover 616, for example. The bracket 732 may serve to anchor the first arm 600 and the second arm 602 to the second carriage 208.

The second carriage 208, as introduced above, includes the first protrusion 606 and the second protrusion 608, which provide therapeutic relief to the back as the second carriage 208 moves along the track 214. The first protrusion 606 and the second protrusion 608 may be disposed a first distance 736 above a bottom 734 of the second carriage 208. The rollers 218 of the roller assembly 216 may be disposed a second distance 738 above the bottom 734. The second distance 738 may be greater than the first distance 736, and the second distance 738 may be variable depending upon actuation of the second actuator 704 and/or the rotation of the roller assembly 216 about the axle 604. As such, in an embodiment, the second distance 738 may be less than the first distance 736.

As introduced above, the first cover 614 further defines the first groove 618 and the second groove 620 that receive the first rail 300 and the second rail 302, respectively. The first protrusion 606 and the second protrusion 608 are spaced apart by the distance 610 to provide a channel, void, space, etc., to accommodate the spine. Additionally, as will be discussed herein, the rollers 218 of the roller assembly 216 may also be spaced apart by a distance to accommodate the spine as well.

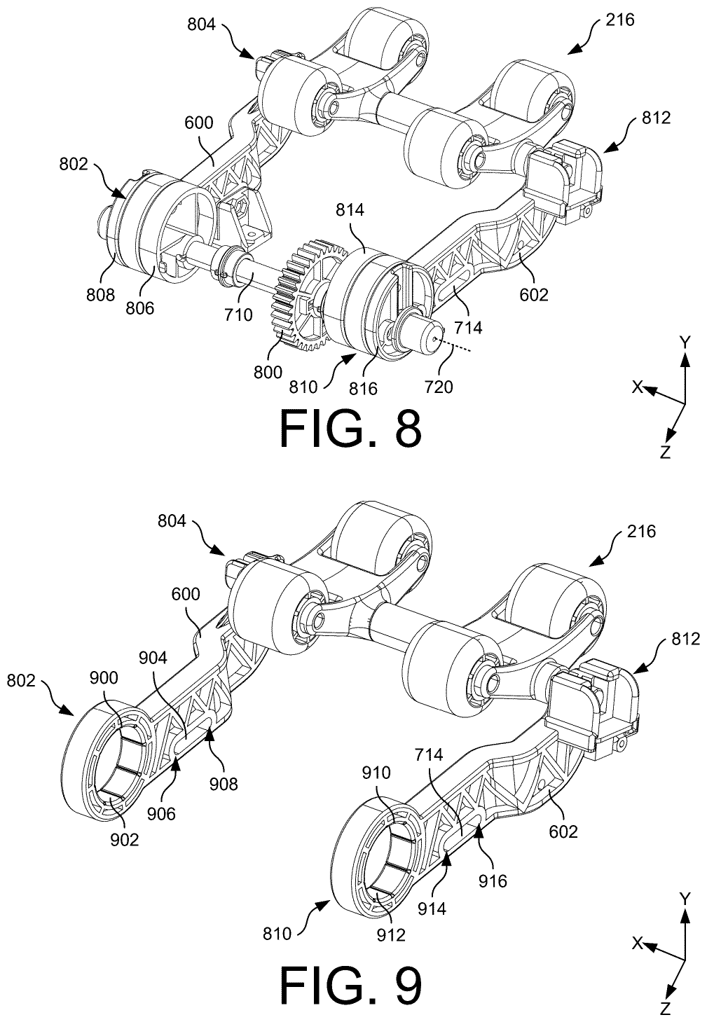

FIG. 8 illustrates an engagement between the shaft 710, the roller assembly 216, the first arm 600, and the second arm 602, according to examples of the present disclosure. As introduced above, the shaft 710 may rotate about the axis of rotation 720 during actuation of the second actuator 704, and via an engagement between the worm gear 706 and the one or more second gears 708. For example, the one or more second gears 708 may include a sprocket 800 mounted about the shaft 710.

The first arm 600 may include a first end 802 and a second end 804 spaced apart from the first end 802. The first end 802 may couple to the shaft 710 via a first collar 806 and a second collar 808. The first collar 806 and the second collar 808 may couple, compress, seat, etc., the first end 802 to the shaft 710. For example, as shown, the first end 802 may be disposed between the first collar 806 and the second collar 808. The first collar 806 and/or the second collar 808 may include features that engage with the first arm 600. In an embodiment, the first collar 806 and the second collar 808 may include grooves, notches, etc., that mate with corresponding grooves, notches, etc., on the shaft 710.

As shown, the shaft 710 may not extend through a center of the first collar 806, the second collar 808, and the first end 802 of the first arm 600. For example, the shaft 710 may be disposed proximate to a periphery or perimeter of the first end 802. Disposing the shaft 710 off center has the effect of causing the first arm 600 to advance in the third direction 724 during rotation of the shaft 710 in the first direction 718, thereby causing the second end 804 of the first arm 600 (and the roller assembly 216) to move in the fourth direction 726. Additionally, during rotation of the shaft 710 in the second direction 722, the second end 804 of the first arm 600 moves in the sixth direction 730. As such, a center of the first end 802 may be non-centric with the shaft 710, or non-centric with the axis of rotation 720.

The second arm 602 may include a first end 810 and a second end 812 spaced apart from the first end 810. The first end 810 may couple to the shaft 710 via a first collar 814 and a second collar 816. The first collar 814 and the second collar 816 may couple, compress, seat, etc. the first end 810 to the shaft 710. For example, the first end 810 may be disposed between the first collar 814 and the second collar 816. The first collar 814 and/or the second collar 816 may include features that engage with the second arm 602. In an embodiment, the first collar 814 and the second collar 816 may include grooves, notches, etc., that mate with corresponding grooves, notches, etc., on the shaft 710.

As shown, the shaft 710 may not extend through a center of the first collar 814, the second collar 816, and the first end 810 of the second arm 602. For example, the shaft 710 may be disposed proximate to a periphery or perimeter of the first end 810. Disposing the shaft 710 off center has the effect of causing the second arm 602 to advance in the third direction 724 during rotation of the shaft 710 in the first direction 718, thereby causing the second end 812 of the second arm 602 (and the roller assembly 216) to move in the fourth direction 726. Additionally, during rotation of the shaft 710 in the second direction 722, the second end 812 of the first arm 600 moves in the sixth direction 730. As such, a center of the first end 810 may be non-centric with the shaft 710 or non-centric with the axis of rotation 720.

Although a particular coupling is shown between the first arm 600, the second arm 602, and the shaft 710, other types of coupling are envisioned. For example, cam mechanisms may be coupled to the shaft 710 and used to impart movement to the first arm 600 and the second arm 602 for raising and lowering the roller assembly 216.

FIG. 9 illustrates additional details of the first arm 600 and the second arm 602, according to examples of the present disclosure. In FIG. 9, the shaft 710, the sprocket 800, the first collar 806, the second collar 808, the first collar 814, and the second collar 816 are shown removed.

The first end 802 of the first arm 600 may include an opening 900 through which the shaft 710 is disposed. The opening 900 may be sized larger than the shaft 710, however, the first collar 806 and the second collar 808 may couple the first end 802 to the shaft 710. For example, at least a portion of the first collar 806 and/or the second collar 808 may be disposed within the opening 900, and form a compression fit with an interior surface 902 thereof to couple the first arm 600 to the shaft 710.

The first arm 600 includes a slot 904 to receive a pin. The slot 904 may be similar to the slot 714. The slot 904 may include a first end 906 and a second end 908. The pin may be similar to the pin 716 and may move within the slot 904, between the first end 906 and the second end 908, as the second actuator 704 impartments movement to the first arm 600. A bracket, which may be similar to the bracket 732, may receive the pin disposed through the slot 904 for coupling the first arm 600 to the second carriage 208.

The first end 810 of the second arm 602 may include an opening 910 through which the shaft 710 is disposed. The opening 910 may be sized larger than the shaft 710, however, the first collar 814 and the second collar 816 may couple the first end 810 to the shaft 710. For example, at least a portion of the first collar 814 and/or the second collar 816 may be disposed within the opening 910, and form a compression fit with an interior surface 912 thereof to couple the second arm 602 to the shaft 710.

The second arm 602 includes the slot 714 to receive the pin 716. The slot 714 may include a first end 914 and a second end 916. The pin 716 may move within the slot 714, between the first end 914 and the second end 916, as the second actuator 704 impartments movement to the second arm 602. The bracket 732 may receive the pin 716 disposed through the slot 714 for coupling the second arm 602 to the second carriage 208.

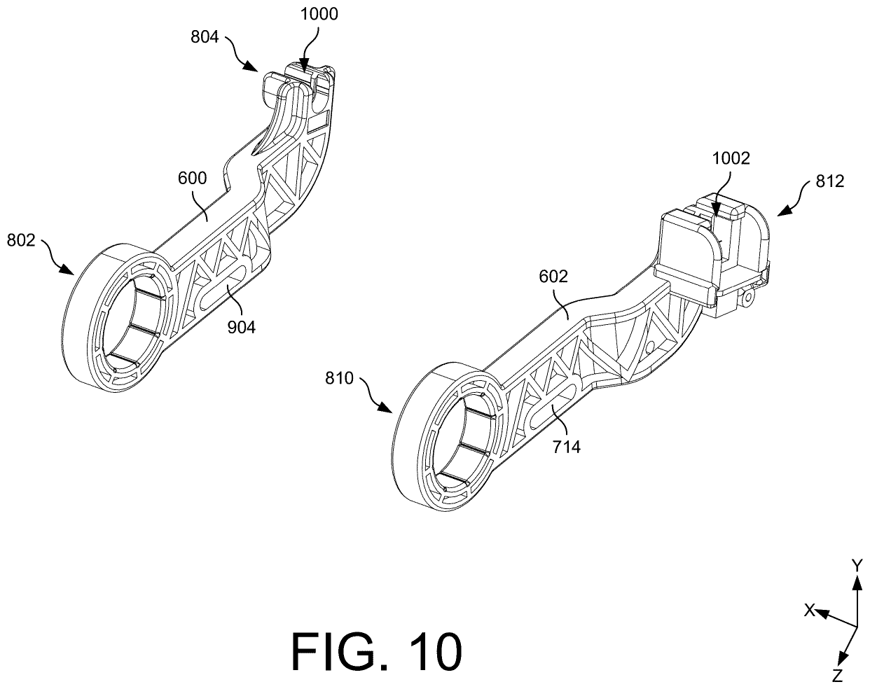

FIG. 10 illustrates the first arm 600 and the second arm 602, according to examples of the present disclosure. As described above, the first arm 600 includes the first end 802 and the second end 804, as well as the slot 904. The second arm 602 includes the first end 810 and the second end 812, as well as the slot 714.

The second end 804 and the second end 812 are configured to receive the axle 604 of the roller assembly 216. The second end 804 may include a receptacle 1000 in which an end of the axle 604 is disposed. Similarly, the second end 812 may include a receptacle 1002 in which an opposite end of the axle 604 is disposed. In an embodiment, the axle 604 may be press-fit, compression-fit, or snapped into engagement within the receptacle 1000 and the receptacle 1002, respectively.

In an embodiment, a sensor (e.g., the sensor(s) 120) may be disposed on the second end 812. The sensor may generate sensor data 122 indicative of whether the axle 604 is disposed within the receptacle 1002, or more generally, whether the roller assembly 216 is coupled to the first arm 600 and the second arm 602. For example, if the sensor data 122 indicates an absence of the axle 604, the myofascial mat 100 may be restricted from operating. Comparatively, if the sensor data 122 indicates a presence of the axle 604, the myofascial mat 100 may be permitted to operate.

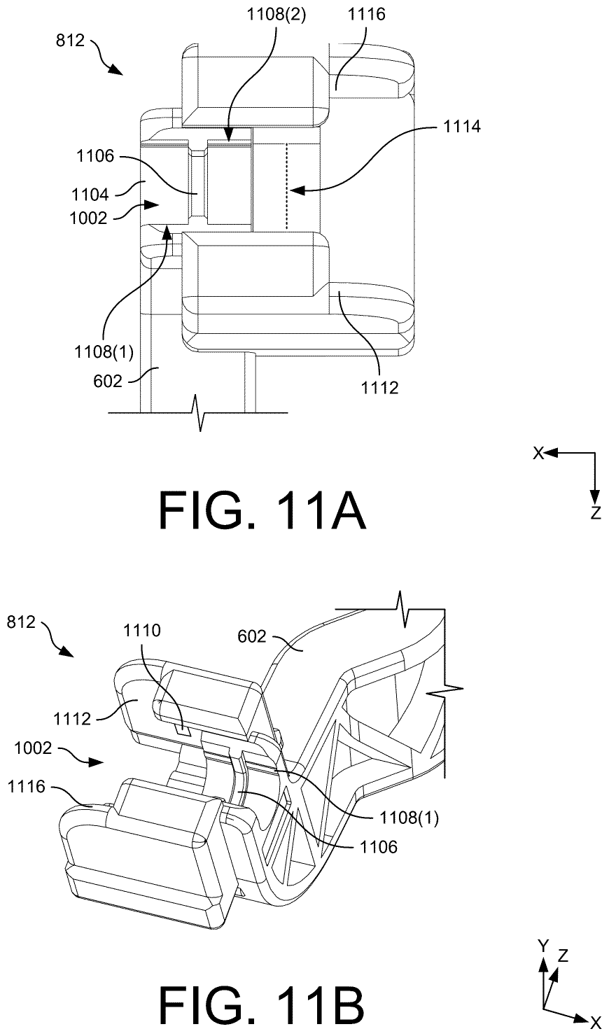

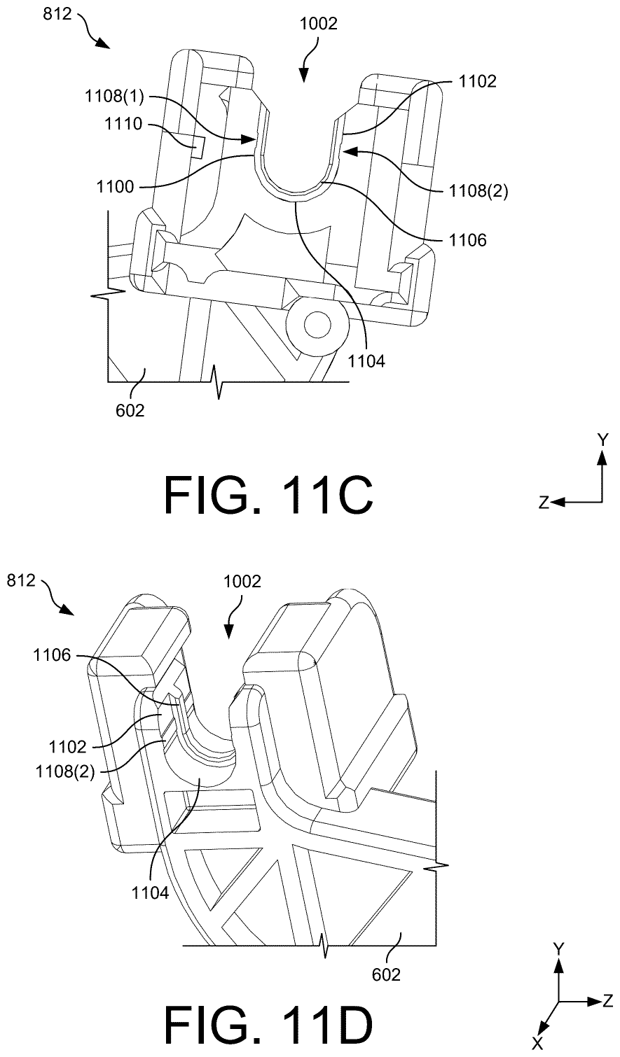

FIGS. 11A-11D illustrate details of the second arm 602, according to examples of the present disclosure. FIG. 11A illustrates a partial top view of the second end 812 of the second arm 602, FIG. 11B illustrates a first partial isometric view of the second end 812 of the second arm 602, FIG. 11C illustrates a partial side view of the second end 812 of the second arm 602, and FIG. 11D illustrates a second partial isometric view of the second end 812 of the second arm 602. Although the discussion of FIGS. 11A-11D is with regard to the second arm 602, the first arm 600 may include similar features.

As introduced above, the roller assembly 216 includes the axle 604 that couples to the second arm 602. For example, the second end 812 of the second arm 602 includes the receptacle 1002 that receives a portion of the axle 604. The receptacle 1002 may be semi-circular in shape (e.g., about the Y-Z plane). In an embodiment, the axle 604 may be press-fit, compression-fit, snap-fit, etc., into the receptacle 1002. For example, an engagement between the axle 604 and the receptacle 1002 may be an interference snap-fit.

In an embodiment, the receptacle 1002 may be defined by one or more opposing sides. For example, the receptacle 1002 may include a first side 1100 and a second side 1102, opposite the first side 1100. The receptacle 1002 may also include a bottom 1104. However, the receptacle 1002 may be open at the top to receive the axle 604. The receptacle 1002 may include a first rib 1106 (e.g., raised protrusion, spine, projection, bulge, etc.) that engages with a channel of the axle 604. For example, the first rib 1106 may be disposed within the channel of the axle 604 to seat, orient, position, etc., the axle 604 within the receptacle 1002, or more generally, the second carriage 208. The first rib 1106 may be “U-shaped” to correspondingly engage with a shaft of the axle 604. The first rib 1106 may extend from the first side 1100, along the bottom 1104, and to the second side 1102.

Additionally, or alternatively, the receptacle 1002 may include one or more second ribs 1108, such as a second rib 1108(1) and a second rib 1108(2). The second rib 1108(1) may be disposed on the first side 1100, while the second rib 1108(2) may be disposed on the second side 1102. When the axle 604 is disposed within the receptacle 1002, the second ribs 1108 may engage with a surface of the axle 604 to prevent the axle 604 from disengaging with the receptacle 1002. For example, when the axle 604 is placed into the receptacle 1002, a major segment of the axle 604 may be disposed beneath the second ribs 1108 (e.g., between the second ribs 1108 and the bottom 1104). In other words, the second ribs 1108 may be disposed above the bottom 1104 by a distance greater than a diameter of the axle 604. When the axle 604 engages within the receptacle 1002, as the axle 604 rolls or is pushed passed the second ribs 1108, the second ribs 1108 may provide a snap-like feel to secure the axle 604 in place. However, upon application of a sufficient amount of force, the axle 604 (and correspondingly the roller assembly 216) may be removed from the receptacle 1002. In an embodiment, the axle 604 may be free to rotate within the receptacle 1002 or may be restricted from rotating within the receptacle 1002.

The second arm 602 may include a sensor 1110 configured to sense the presence of the axle 604 within the receptacle 1002 or whether the axle 604 is secured to the second arm 602, for example. In an embodiment, the sensor 1110 may be disposed on a first sidewall 1112 at the second end 812. The sensor 1110 may output a signal 1114 in a direction towards a second sidewall 1116 that opposes the first sidewall 1112. The signal 1114 is shown in dashed lines in FIG. 11A. In instances in which the axle 604 is disposed in the receptacle 1002, the sensor 1110 may not receive the signal 1114. In turn, when the sensor 1110 does not receive the signal 1114, the myofascial mat 100 may be permitted to operate. That is, when the axle 604 is disposed within the receptacle 1002 and coupled to the second arm 602, the myofascial mat 100 is permitted to operate. Comparatively, in instances in which the axle 604 is absent and/or is improperly secured within the receptacle 1002, the signal 1114 may be received by the sensor 1110. In these instances, the myofascial mat 100 may be restricted from operating. For example, because the axle 604 is not secured within the receptacle 1002 and/or is absent from the receptacle 1002, the myofascial mat 100 may be restricted from operating.

Examples of the sensor 1110 include an IR emitter, RF transmitter and receiver, contact sensor, proximity sensor, etc. Moreover, although described as being mounted to the second arm 602, the sensor 1110 may be mounted elsewhere on the second carriage 208 and/or the myofascial mat 100. In an embodiment, the sensor 1110 may be disposed on one of the first arm 600 or the second arm 602, and/or both of the first arm 600 and the second arm 602.

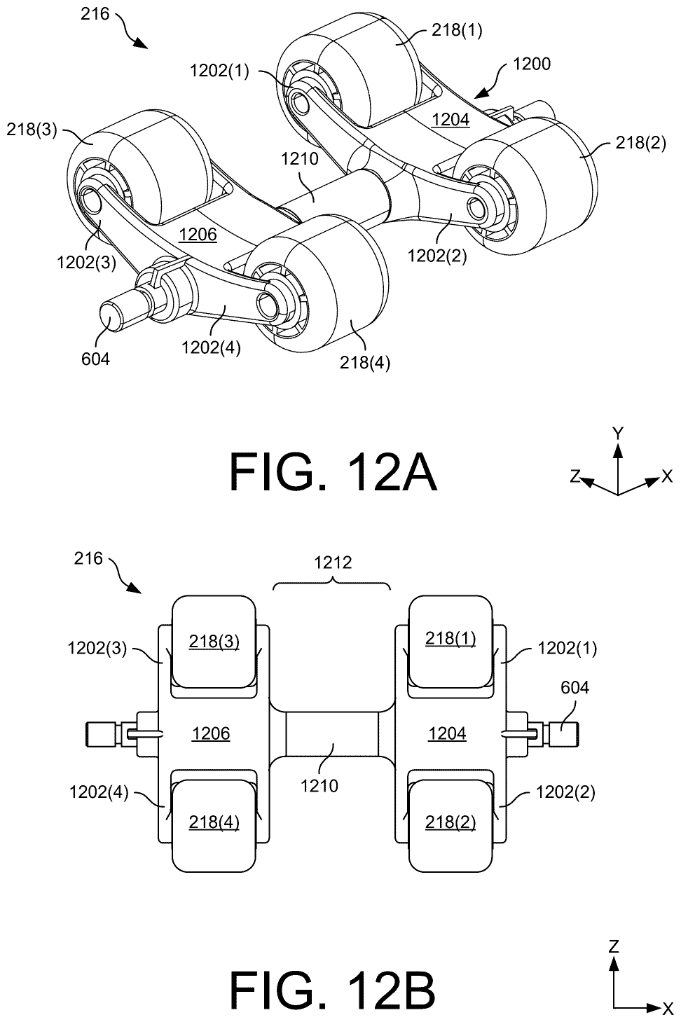

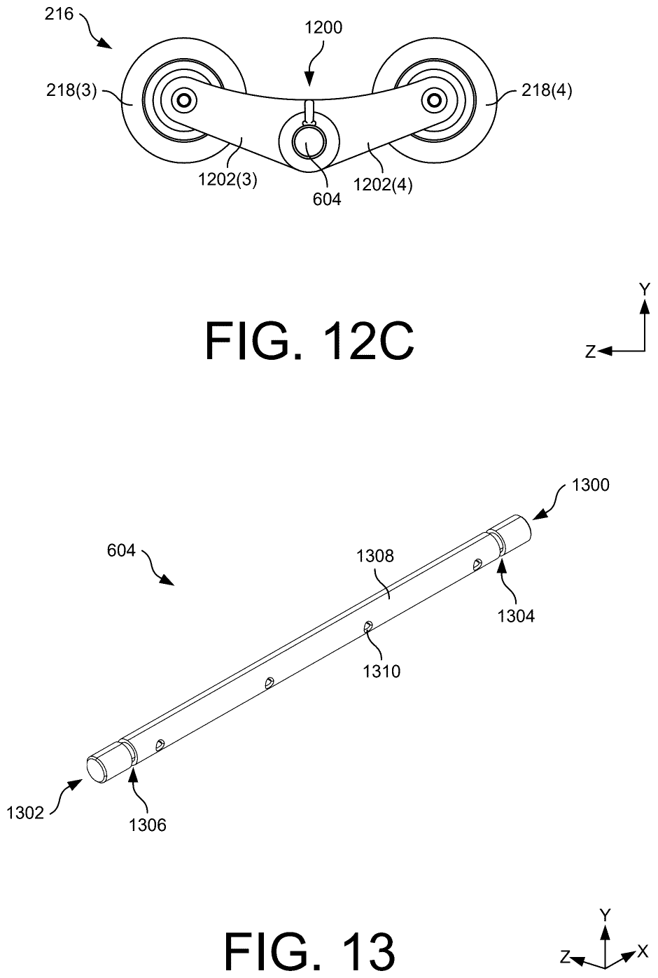

FIGS. 12A-12C illustrate details of the roller assembly 216, according to examples of the present disclosure. FIG. 12A illustrates an isometric view of the roller assembly 216, FIG. 12B illustrates a top view of the roller assembly 216, and FIG. 12C illustrates a side view of the roller assembly 216.

The roller assembly 216 includes a frame 1200 through which the axle 604 is disposed. The frame 1200 may include one or more swingarms 1202 for receiving the rollers 218. For example, a first body 1204 of the frame 1200 may include a first swingarm 1202(1) for receiving a first roller 218(1) and a second swingarm 1202(2) for receiving a second roller 218(2). A second body 1206 of the frame 1200 may include a third swingarm 1202(3) for receiving a third roller 218(3) and a fourth swingarm 1202(4) for receiving a fourth roller 218(4). In an embodiment, the first body 1204 and the second body 1206 may be affixed to the axle 604, or the first body 1204 and the second body 1206 may be free to rotate independently of the axle 604. The first body 1204 and the second body 1206 may be free to rotate independently of one another. The pivoting action of the first body 1204 and the second body 1206 allow the roller assembly 216 to contour to the back of the user. A bushing 1210 may be disposed between the first body 1204 and the second body 1206. The bushing 1210 may be affixed to the axle 604 or may be free to rotate independently of the axle 604.

Each of the swingarms 1202 includes one or more arms, such as a first arm and a second arm. A shaft, axle, etc. may be disposed through the rollers 218, respectively, between the first arm and the second arm of each of the swingarms 1202, respectively. The rollers 218 may therefore be rotatable about the shaft.

The first body 1204 and the second body 1206 may be spaced apart by a distance 1212, which may be similar to the distance 610. Alternatively, the distance 1212 may be disposed between the first roller 218(1) and the third roller 218(3) or the second roller 218(2) and the fourth roller 218(4). The distance 1212 may accommodate the spine of the user, for example, such that the first roller 218(1) and the second roller 218(2) may roll along a left side of the spine of the user and the third roller 218(3) and the fourth roller 218(4) may roll along a right side of the spine of the user.

Although a particular size, shape, surface finish, etc. of the rollers 218 are shown, the rollers 218 may be shaped differently, such as being triangular, hexagonal, etc., to provide different therapeutic relief to the user. In an embodiment, the surface of the rollers 218 may be smooth, textured, or bumpy (e.g., dimples, protrusions, etc.). Moreover, although a certain number of the rollers 218 is shown, the roller assembly 216 may include a greater number or lesser number of the rollers 218.

As shown, the first body 1204 and the second body 1206 may include a Y-shape (e.g., about the Y-Z plane). The Y-shape of the first body 1204 and the second body 1206 may dispose a rolling surface of the rollers 218 above (e.g., in the Y-direction) the frame 1200. This separation may prevent the back of the user from contacting, abutting, rolling against, etc., the frame 1200 during use.

FIG. 13 illustrates an isometric view of the axle 604, according to examples of the present disclosure. The axle 604 may be a component of the roller assembly 216 for coupling to the second carriage 208. The axle 604 may include a first end 1300 and a second end 1302 spaced apart from the first end 1300 (e.g., in the X-direction). The first end 1300 may couple to the first arm 600, at the second end 804, while the second end 1302 may couple to the second arm 602, at the second end 812. More particularly, the first end 1300 may be disposed within the receptacle 1000 of the first arm 600 and the second end 1302 may be disposed within the receptacle 1002 of the second arm 602.

The axle 604 includes a first channel 1304 and a second channel 1306 formed in an exterior surface 1308 of the axle 604. The first channel 1304 may be disposed proximate to the first end 1300 and the second channel 1306 may be disposed proximate to the second end 1302. The first channel 1304 and the second channel 1306 may represent grooves, passages, etc., formed within the exterior surface 1308. The first channel 1304 may engage with a rib disposed at the second end 804 of the first arm 600, for example, such that the rib (e.g., similar to the first rib 1106) is disposed within the first channel 1304 to seat, orient, lock, secure, etc. the axle 604 to the first arm 600. The second channel 1306 may engage with a rib disposed at the second end 812 of the second arm 602, for example, such that the first rib 1106 is disposed within the second channel 1306 to seat, orient, lock, secure, etc., the axle 604 to the second arm 602.

In an embodiment, the axle 604 may include one or more through holes 1310 that couple the first body 1204, the second body 1206, and/or the bushing 1210 to the axle 604. For example, fasteners may be disposed into the through holes 1310 for coupling the first body 1204, the second body 1206, and/or the bushing 1210 to the axle 604.

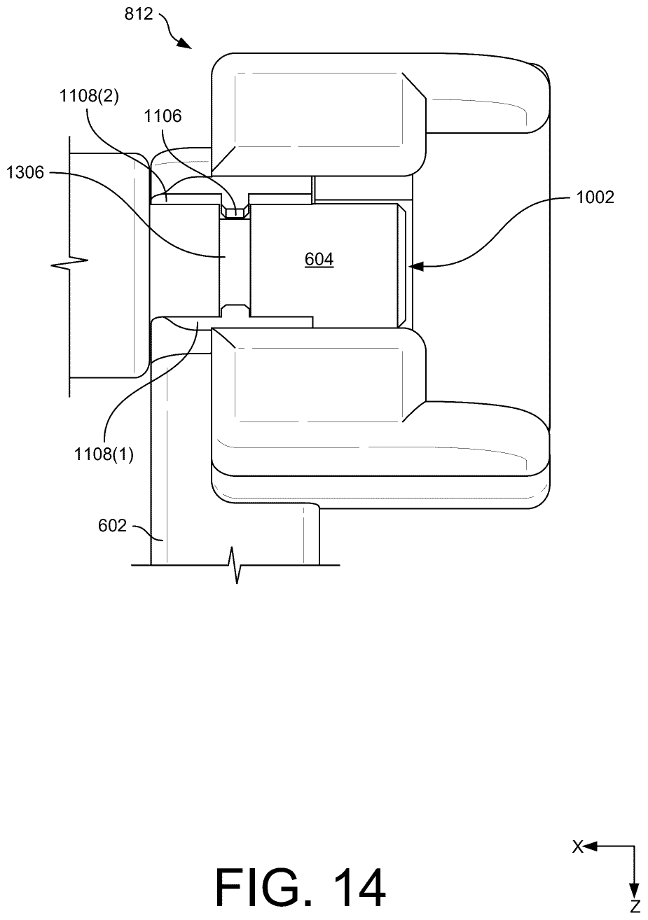

FIG. 14 illustrates an engagement between the roller assembly 216 and the second carriage 208, according to examples of the present disclosure. More particularly, FIG. 14 illustrates an engagement between the axle 604 and the second arm 602. However, although described herein with regard to an engagement between the axle 604 and the second arm 602, the axle 604 may engage with the first arm 600 in a similar manner.

The second end 1302 of the axle 604 is disposed within the receptacle 1002 at the second end 812 of the second arm 602. The first rib 1106 may be disposed within the second channel 1306, for example, to align, seat, etc., the axle 604 on the second arm 602. An engagement between the first rib 1106 and the second channel 1306, as well as the rib and the first channel 1304, may prevent the axle 604 laterally translating (e.g., in the X-direction). Moreover, when the axle 604 is disposed within the receptacle 1002, the second ribs 1108 may be disposed over the exterior surface 1308 to secure the axle 604 within the receptacle 1002. In an embodiment, magnetic elements may be disposed within the receptacle 1002 and/or the receptacle 1002 and attract to the axle 604 to further secure the roller assembly 216 to the first arm 600 and the second arm 602.

The sensor 1110 is configured to sense the presence of the axle 604 within the receptacle 1002 or whether the axle 604 is secured to the second arm 602. As shown, being as the axle 604 is disposed within the receptacle 1002, the sensor 1110 may detect the presence of the axle 604 (e.g., based on a lack of receipt of the signal 1114). In such instances, the myofascial mat 100 may be permitted to operate. For example, the first carriage 206 and the second carriage 208 may be permitted to traverse along the track 214 to provide therapeutic relief.

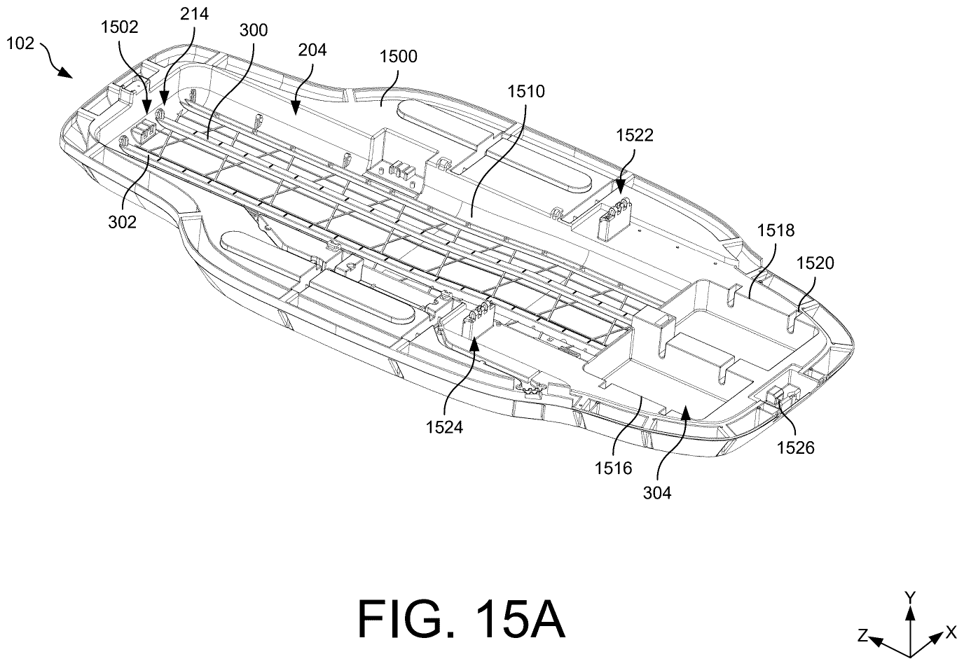

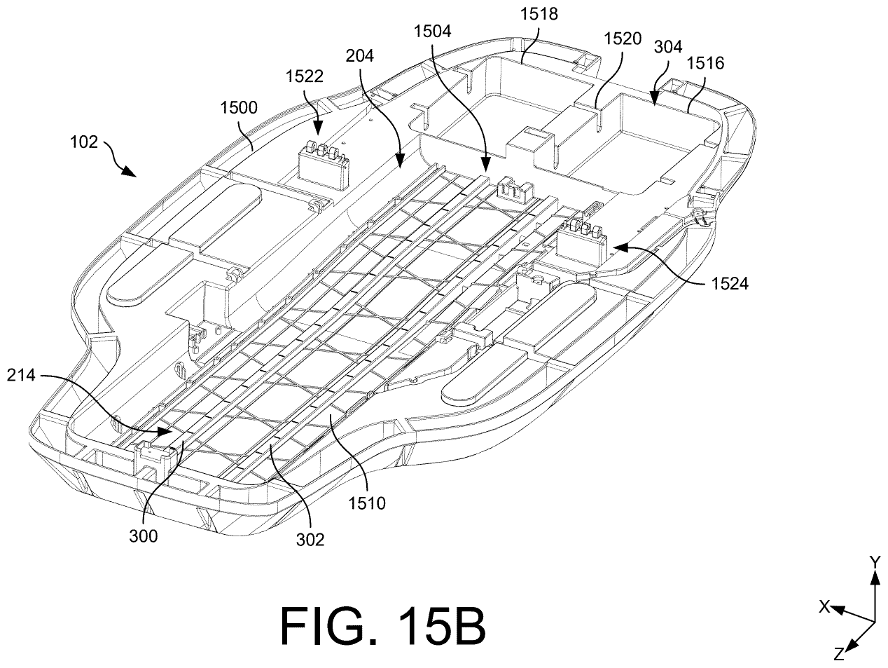

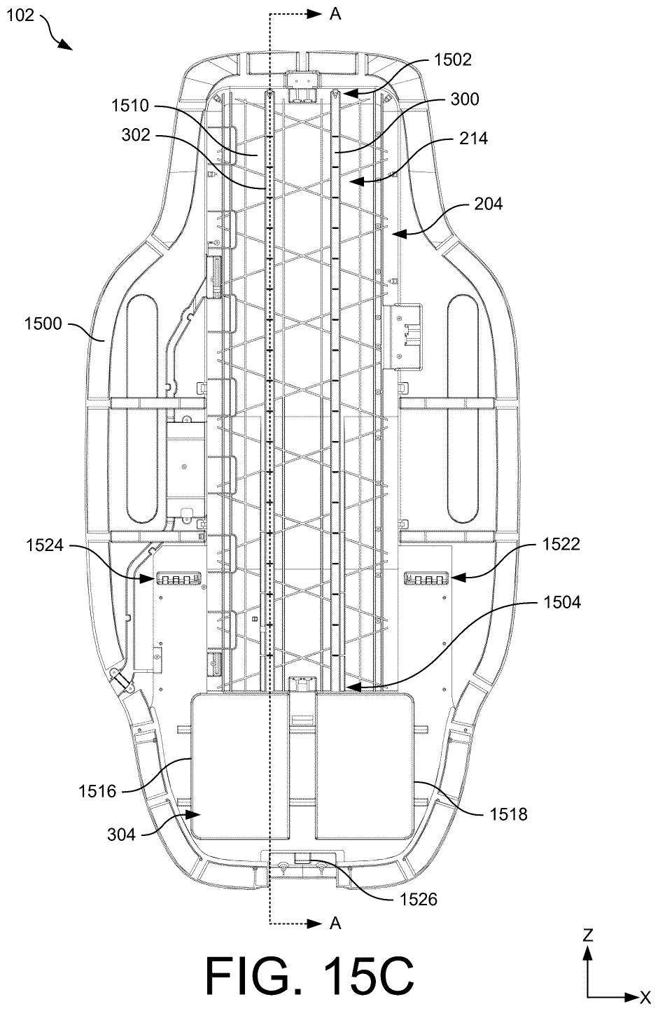

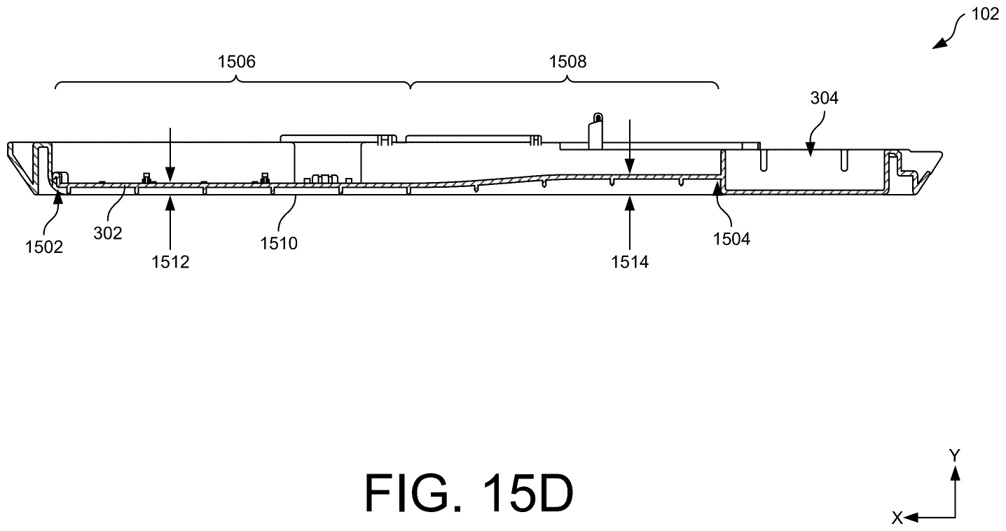

FIGS. 15A-15D illustrate details of the base 102, according to examples of the present disclosure. FIG. 15A illustrates a first isometric view of the base 102, FIG. 15B illustrates a second isometric view of the base 102, FIG. 15C illustrates a top view of the base 102, and FIG. 15D illustrates a cross-sectional view of the base 102, taken along line A—A of FIG. 15C.

The base 102 at least partially defines the internal compartment 204. The pieces of foam 104 couple to the base 102, such as along a top surface 1500 of the base 102. The track 214, which may include the first rail 300 and the second rail 302, are disposed along a bottom 1510 of the internal compartment 204. In an embodiment, the track 214 (or the first rail 300 and the second rail 302) may include a first end 1502 proximate to the first end 108 of the myofascial mat 100 and a second end 1504 proximate to the second end 110 of the myofascial mat 100. As introduced above, the first carriage 206 may be disposed more proximate to the first end 1502 and move in the first direction 400 towards the second end 1504 to be positioned adjacent to the neck. However, the first carriage 206 may also move in the second direction 402.

The second carriage 208 may be disposed more proximate to the second end 1504 as compared to the first carriage 206. Once the first carriage 206 is in position adjacent to the neck, the second carriage 208 may move along a length of the track 214 between the second end 1504 and the first carriage 206. For example, the second carriage 208 may move in the second direction 402 towards the first carriage 206. The sensor 544 may be used to detect when the second carriage 208 is adjacent to the first carriage 206, and therein, the second carriage 208 may move in the first direction 400 towards the second end 1504. Therein, the sensor 622 may be used to detect when the second carriage 208 is adjacent or has reached the second end 1504, at which point, the second carriage 208 may begin moving in the first direction 400 again.

In an embodiment, the first rail 300 and the second rail 302 may be coupled to the base 102 or integrated into the base 102. Although shown as including the first rail 300 and the second rail 302, the track 214 may include more than two rails (e.g., three) or less than two rails. The first rail 300 and the second rail 302 may also be identical.

The first rail 300 and the second rail 302 include a length disposed between the first end 1502 and the second end 1504. A first portion 1506 of the first rail 300 and the second rail 302 may be planar (e.g., flat, straight, etc.), while a second portion 1508 of the first rail 300 and the second rail 302 may be curved (e.g., inclined, ramped, sloped, etc.). For example, the second portion 1508, which may be located proximate to the second end 1504, may be disposed vertically above the first portion 1506. In an embodiment, the first portion 1506 is spaced apart from the bottom 1510 by a first distance 1512, while the second portion 1508 may be spaced apart from the bottom 1510 by a second distance 1514 that is greater than the first distance 1512. The first portion 1506 may extend a first length of the first rail 300 and the second rail 302. The second portion 1508 may extend a second length of the first rail 300 and the second rail 302. The second length may be less than the first length. The first rail 300 and the second rail 302 may include a smooth, gradual, etc. interface between the first portion 1506 and the second portion 1508.

The second portion 1508 may be curved to bring the second carriage 208, or the roller assembly 216, closer to the back and/or follow a curvature of the back. For example, the thoracic, lumbar, and/or sacrum regions may have a natural curvature. To match, accommodate, etc., this curvature, the first rail 300 and the second rail 302 may extend towards the user (e.g., in the Y-direction). This allows the rollers 218 to maintain an engagement with the back to provide therapeutic relief. Moreover, as introduced above, the second actuator 704 may additionally actuate to bring the rollers 218 into engagement with the back. Although not shown, the gear rack 212 may couple to the base 102, such as along the bottom 1510. Additionally, the gear rack 212 may follow a similar profile as the first rail 300 and the second rail 302.

The base 102 defines the storage compartment 304, which may include a first pocket 1516 (e.g., receptacle, cavity, chamber, etc.) and a second pocket 1518. The first pocket 1516 and the second pocket 1518, as will be discussed herein, are accessible via opening the lid 132. The first pocket 1516 and the second pocket 1518 may be similar or different in size, shape, etc. The first pocket 1516 and the second pocket 1518 may be sized to receive different roller assemblies, for example, for interchanging with the roller assembly 216 to provide different therapeutic relief. The base 102 may include slots 1520 in which axles of the other roller assemblies are disposed to seat the roller assemblies within the first pocket 1516 and the second pocket 1518, respectively.

The myofascial mat 100 may include a first hinge 1522 and a second hinge 1524. The base 102 may define a first portion of the first hinge 1522 and the second hinge 1524. For example, the base 102 may define or include leaves, knuckles, etc., that make up portions of the first hinge 1522 and the second hinge 1524. The base 102 also includes a receptacle 1526 (e.g., hook, tab, etc.) that may engage with a corresponding feature of the lid 132 to lock or latch the lid 132 to the base 102.

FIGS. 16A and 16B illustrate a functionality of the lid 132 and an use of the storage compartment 304, according to examples of the present disclosure. FIG. 16A illustrates an isometric view of the myofascial mat 100 and FIG. 16B illustrates a partial view of the myofascial mat 100.

In FIGS. 16A and 16B, the lid 132 is shown in the open position, thereby providing access to the storage compartment 304. For example, from the view of the myofascial mat 100 shown in FIG. 1 in which the lid 132 is in the closed position, the lid 132 may be rotated (e.g., counterclockwise about the X-axis) to the open position. In an embodiment, the lid 132 may be rotated 90 degrees from the closed position to the open position. The first hinge 1522 and the second hinge 1524 permit the lid 132 to rotate. Moreover, when rotated between the closed position and the open position, the cover 106 may scrunch, roll, fold, etc. over itself.

The storage compartment 304 is shown including a roller assembly 1600 (e.g., the roller assembly 216(1)) and a roller assembly 1602 (e.g., the roller assembly 216(2)), which may be interchangeable with the roller assembly 216 (e.g., the roller assembly 216(1)) coupled to the second carriage 208. The roller assembly 1600 may be disposed in the first pocket 1516, while the roller assembly 1602 may be disposed in the second pocket 1518. Moreover, axles of the roller assembly 1600 and the roller assembly 1602 may be disposed within the slots 1520 for seating, securing, etc.

When the lid 132 is open, the roller assembly 216 is shown being accessible such that the roller assembly 216 may be interchangeable with the roller assembly 1600 or the roller assembly 1602. In an embodiment, the roller assembly 216 may be pulled (e.g., in the Y-direction) to uncouple the axle 604 from the first arm 600 and the second arm 602, respectively. When the lid 132 is moved to the open position, in an embodiment, the second carriage 208 may be moved to the second end 1504 of the first rail 300 and the second rail 302, thereby making the roller assembly 216 accessible to interchange with the roller assembly 1600 or the roller assembly 1602. In an embodiment, a sensor 1604 (e.g., the sensor(s) 120) may sense a movement of the lid 132 to the open position, and thereafter, the second carriage 208 may be caused to move to the second end 1504. Additionally, or alternatively, when the myofascial mat 100 is powered off, the second carriage 208 may be caused to move to the second end 1504 such that the roller assembly 216 is replaceable.

However, in an embodiment, when the lid 132 is in the open position, the myofascial mat 100 may be restricted from operating or performing certain operations. For example, the first carriage 206 may be restricted from moving, the second carriage 208 may be restricted from moving, the actuator 704 may be restricted from moving the roller assembly 216 up and down, and so forth. If the user desires to change the roller assembly 216 with one of the roller assembly 1600 or the roller assembly 1602, and the roller assembly 216 is not accessible via the storage compartment 304, the user may press a button, switch, lever, etc. For example, the user may press a button to move the second carriage 208 to the second end 1504 such that the roller assembly 216 is accessible. If the lid 132 is moved to the open position while the second carriage 208 is moving, movement of the second carriage 208 may be halted. Therein, upon closing the lid 132, the second carriage 208 may resume moving to the second end 1504. As another example, if the button is pressed while the lid 132 is in the open position, the lid 132 may be closed before movement of the second carriage 208 is permitted. Sensor(s) 120 may be disposed on the base 102, the lid 132, a latch 1606, etc., for detecting when the lid 132 is in the closed position, open position, etc.

The lid 132 is shown including the latch 1606 that may engage with the receptacle 1526. An engagement between the latch 1606 and the receptacle 1526 may keep the lid 132 in the closed position. The latch 1606 may be pressed, pulled, etc., to disengage from the receptacle 1526 to permit the lid 132 to transition to the open position.

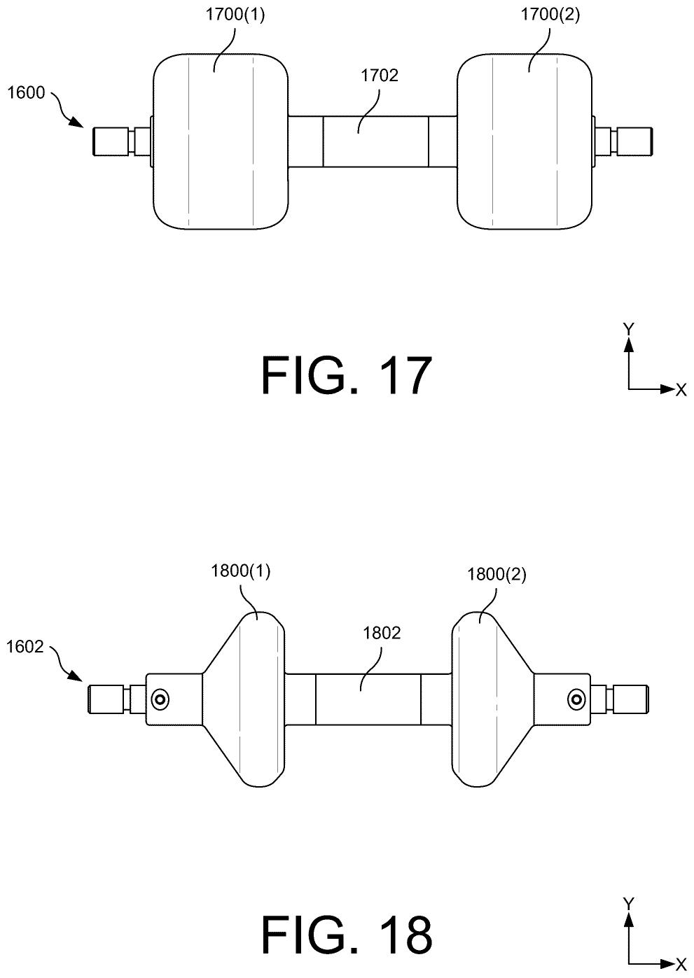

FIG. 17 illustrates the roller assembly 1600, according to examples of the present disclosure. Compared to the roller assembly 216, the roller assembly 1600 may include two rollers, such as a first roller 1700(1) and a second roller 1700(2). The first roller 1700(1) and the second roller 1700(2) may be mounted about an axle 1702, which may be similar to the axle 604. For example, the axle 1702 may include channels for engaging with the first rib 1106.

FIG. 18 illustrates the roller assembly 1602, according to examples of the present disclosure. Compared to the roller assembly 216, the roller assembly 1602 may include two rollers, such as a first roller 1800(1) and a second roller 1800(2). The first roller 1800(1) and the second roller 1800(2) may be mounted about an axle 1802, which may be similar to the axle 604. For example, the axle 1802 may include channels for engaging with the first rib 1106.

The first roller 1800(1) and the second roller 1800(2) may also be narrower than the rollers 218 and/or the rollers 1700, thereby applying more pressure to the back of the user, for example. In an embodiment, the rollers 218, the rollers 1700, and/or the rollers 1800 may include different surface finishes, durometers, materials, etc. For example, the surfaces may include dimples, ridges, grooves, knobs, etc. The durometers and/or materials may differ to provide varying feels (e.g., softness). Although particular rollers are shown, the rollers may be different than shown and/or the roller assemblies may be different than shown. The rollers of the roller assemblies may be spaced apart by the distance 610 to accommodate the spine of the user, for example, and to roll along opposing sides of the spine.

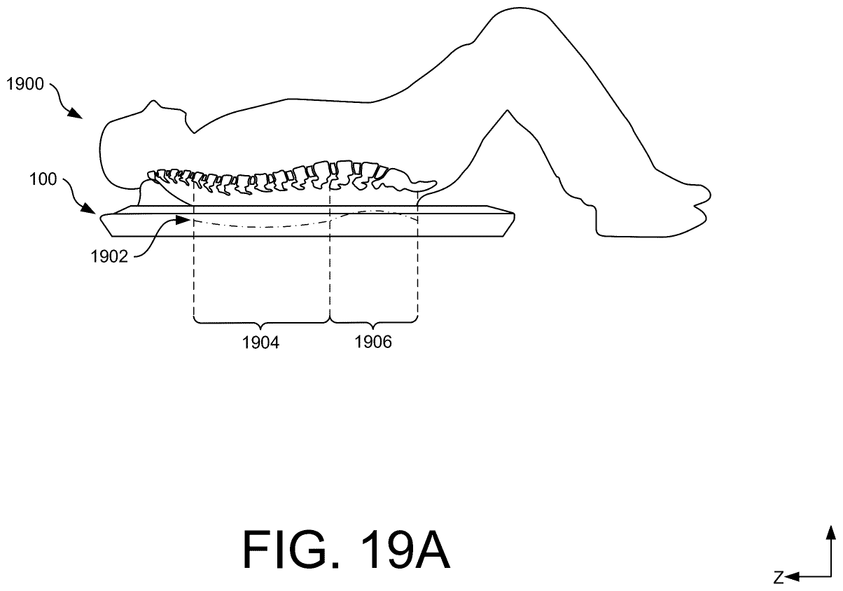

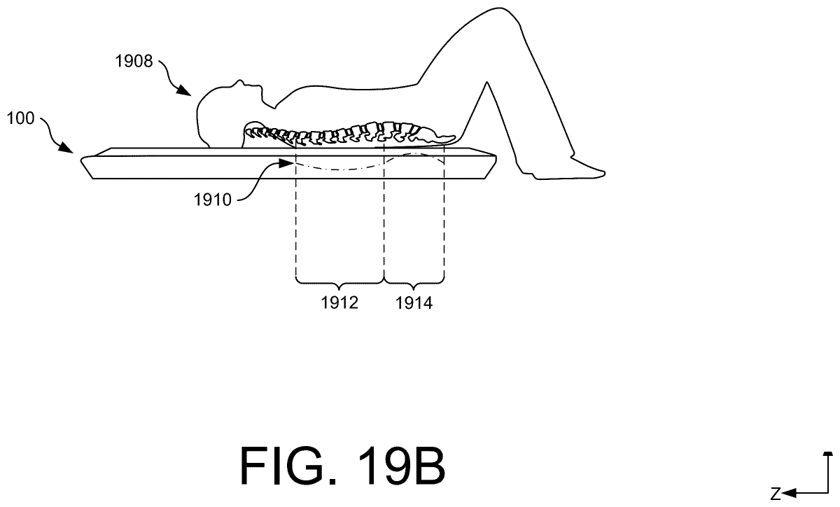

FIGS. 19A and 19B illustrate different paths of the rollers 218 for different users, according to examples of the present disclosure. For example, depending upon the height of the user, the paths of the rollers 218 along the track 214 may be different.

In FIG. 19A, a first user 1900 is shown lying on the myofascial mat 100. The first carriage 206 is in position adjacent to the head/neck of the first user 1900. For example, as discussed above, once the first user 1900 lays the myofascial mat 100, the first carriage 206 may be moved into position. The location of the first carriage 206 along the track 214 may set or be used to determine a length of the track 214 traveled by the second carriage 208. For example, as shown in FIG. 19A, the second carriage 208 may have a first path 1902. The first path 1902 may have a first segment 1904 and a second segment 1906. In an embodiment, the first segment 1904 may represent ⅔ of a length of the first path 1902 and the second segment 1906 may represent ⅓ of the length of the first path 1902. The length of the first path 1902 may be defined between the second end 1504 and the first carriage 206.

As shown, along the first segment 1904, the first path 1902 may have a first shape or profile, whereas along the second segment 1906, the first path 1902 may have a second shape or profile. In an embodiment, the profile of the first segment 1904 and the second segment 1906 may correspond to the shape of the spine of the first user 1900. In other words, the segments of the first path 1902 may accommodate the height of the first user 1900. As the second carriage 208 moves along the first rail 300 and the second rail 302, the rollers 218 may vertically translate, via actuation of the second actuator 704, follow the first path 1902. The first user 1900, however, may have the ability to adjust the pressure applied by the rollers 218 along the first path 1902, for example, via actuating the second actuator 704 (e.g., thereby raising and lowering the rollers 218 into the back of the first user 1900).

In FIG. 19B, a second user 1908 is shown lying on the myofascial mat 100. The first carriage 206 is adjacent to the head/neck of the second user 1908. For example, once the second user 1908 lays the myofascial mat 100, the first carriage 206 may be moved into position. Compared to the first user 1900, the second user 1908 is shorter. For example, the first user 1900 may be 196 cm and the second user 1908 may be 157 cm. However, the first carriage 206 may be moved into position to accommodate different users. The first carriage 206 as shown in FIG. 19B may move by a greater distance away from the first end 1502 to dispose the massagers 210 adjacent to the neck of the second user 1908.

The location of the first carriage 206 along the track 214 may set or be used to determine a length of the track 214 traveled by the second carriage 208. For example, as shown in FIG. 19B, the second carriage 208 may have a second path 1910. The second path 1910 may have a first segment 1912 and a second segment 1914. In an embodiment, the first segment 1912 may represent ⅔ of a length of the second path 1910 and the second segment 1906 may represent ⅓ of the length of the second path 1910. The length of the second path 1910 may be defined between the second end 1504 and the first carriage 206.

Along the first segment 1912 the second path 1910 may have a first shape or profile, whereas along the second segment 1914 the second path 1910 may have a second shape or profile. In an embodiment, the profile of the first segment 1912 and the second segment 1914 may correspond to the shape of the spine of the second user 1908. In other words, the segments of the second path 1910 may accommodate the height of the second user 1908. As the second carriage 208 moves along the first rail 300 and the second rail 302, the rollers 218 may vertically translate, via actuation of the second actuator 704, follow the second path 1910. The second user 1908, however, may have the ability to adjust the pressure applied by the rollers 218 along the second path 1910, for example, via actuating the second actuator 704 (e.g., thereby raising and lowering the rollers 218 into the back of the second user 1908).

The second path 1910 may be shorter than the first path 1902. However, the first segment 1904 and the second segment 1906 may be proportional to the first segment 1912 and the second segment 1914. In an embodiment, the paths of the second carriage 208 may be condensed horizontally (e.g., in the Z-direction) between different users. However, in an embodiment, the vertical translation of the rollers 218 (e.g., in the Y-direction) may not be different between different users.

The first path 1902 and the second path 1910 are exemplary. For example, in an embodiment, the first path 1902 and/or the second path 1910 may include more than two segments or less than two segments. Moreover, the profile of the segments of the paths may be different than shown and described. For example, the first segment 1904 may be flat, while the second segment 1906 may be curved. More segments, for example, may more closely follow the curvature of the spine. Additionally, although the first segment 1904 is described as being ⅔ of the length of the path, other ratios are envisioned.

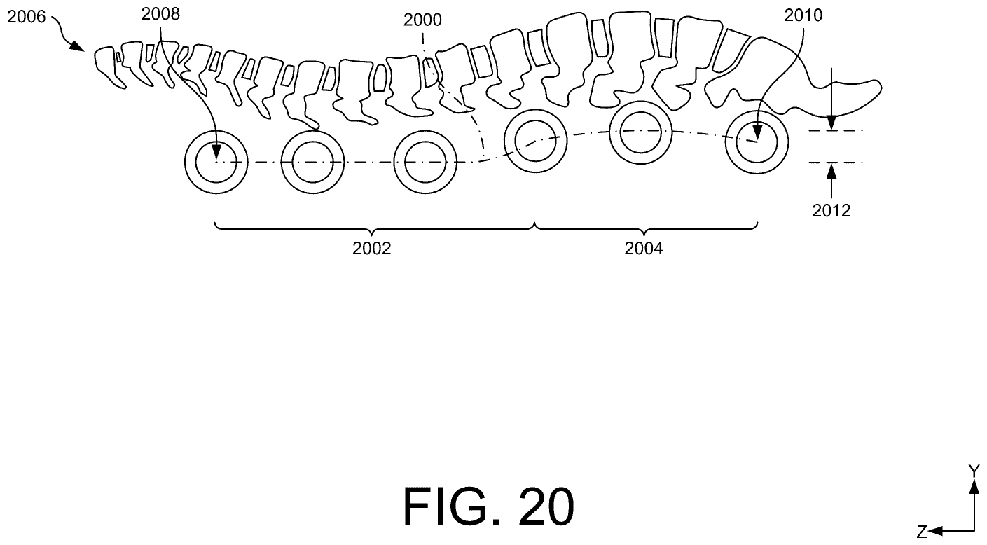

FIG. 20 illustrates an example path 2000 of the rollers 218, according to examples of the present disclosure. As introduced above, paths of the rollers 218 may be determined based at least in part on the location of the first carriage 206 along the track 214 to dispose the massagers 210 adjacent to the neck of the user.

The path 2000 includes a first segment 2002 and a second segment 2004. The first segment 2002 may include a first profile, such as being planar, while the second segment 2004 may include a second profile, such as being curved. As discussed above, the different segments of the path 2000 may allow the rollers 218 to follow a shape of a spine 2006 of the user. In an embodiment, the path 2000 includes a first end 2008 and a second end 2010. The first end 2008 may be disposed adjacent to the first carriage 206, while the second end 2010 may coincide with the second end 1504. The second carriage 208 may move between the first end 2008 and the second end 2010, in the first direction 400 and the second direction 402.

The first segment 2002 may include a first length greater than a second length of the second segment 2004. In an embodiment, the first segment 2002 may be ⅔ of the length of the path 2000 and the second segment 2004 may be ⅓ of the length of the path 2000. Along the first segment 2002 and the second segment 2004, the rollers 218 may be vertically translated to apply different pressures to the user and to conform to the spine 2006. In an embodiment, a peak of the second segment 1906 may be disposed by a distance 2012 from the first segment 2002. The distance 2012, in an embodiment, may be 30 millimeters. However, the path 2000 of the rollers 218 along the first segment 2002 and/or the second segment 2004 may be shifted via the remote 126, for example.

In an embodiment, the pressure applied by the rollers 218 may be measured. For example, sensor(s) 120, such as a load cell, may be disposed on the first arm 600 and/or the second arm 602 to measure an amount of pressure. The pressure may also be transferred to the pin 716, which may, in turn, be measured via a load cell disposed between the bracket 732 and the second cover 616. In another embodiment, the sensor(s) 120 may measure an amount of resistance felt by the second actuator 704. The pressure may be used to adjust the position of the rollers 218, for example, to avoid injuring the user and/or to apply predetermined amounts of pressure along the path 2000, or segments of the path 2000. For example, using the feedback from the sensor(s) 120, the myofascial mat 100 may determine whether to raise or lower the rollers 218 to apply more or less pressure to the user. The amount of pressure applied may be recorded associated with the location of the second carriage 208 along the track 214 or the location of the rollers 218 along the path 2000.

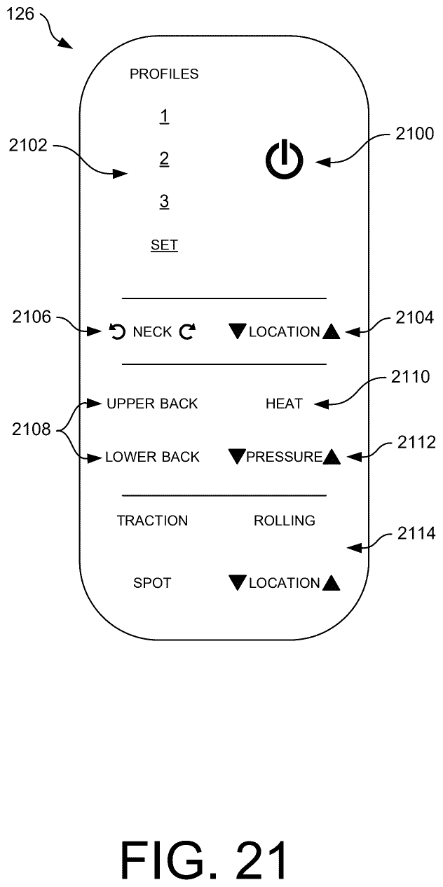

FIG. 21 illustrates details of the remote 126, according to examples of the present disclosure. The remote 126 may be used to control one or more operations of the myofascial mat 100. The remote 126 may include a power button 2100 for powering on and off the myofascial mat 100. The remote 126 may be preprogrammed for different users, in accordance with the profile(s) 128. For example, the profile(s) 128 may include a location of the first carriage 206 on the track 214 to position the massagers adjacent to the neck to accommodate different users. The profile(s) 128 may also indicate pressures to be applied as the rollers 218 traverse along the path (e.g., via the second actuator 704), and length of the segments of the path, and/or other preference(s) of the user. For example, upon powering on the myofascial mat 100, the user may select an indication 2102 of the profile 128. Therein, the myofascial mat 100 may be controlled according to the setting(s) 136 stored in association with the profile(s) 128. The user may also be able to set a profile, for example, by pressing the indication 2102 when the first carriage 206 is in position adjacent to the neck.

The user may use an indication 2104 to change the location of the first carriage 206 along the track 214, for example, in the first direction 400 and the second direction 402. An indication 2106 may control a rotation of the massagers 210, for example, whether counterclockwise or clockwise. In an embodiment, the massagers 210 may rotate in different directions or similar directions.

Indications 2108 may be used to control a location of the second carriage 208 along the track 214. For example, the user may desire to have the rollers 218 remain at a particular along the track 214 or to focus on a particular area of the back (e.g., the upper back, the lower back, etc.). In such instances, the path of the rollers 218 may be controlled according to the desire of the user to traverse a certain segment of the path. An indication 2110 may power heat via the heating element(s) 134 on and off, or to control an amount of heat. An indication 2112 may control the second actuator 704 to adjust the amount of pressure applied by the rollers 218.

Indications 2114 may control other features of the myofascial mat 100, such as a path of the rollers, the speed of the rollers 218, how the rollers 218 move along the path and/or the segments, and so forth. For example, the second carriage 208 may remain stationary at a particular location along the track 214. Still, the second actuator 704 may move the rollers 218 in a circular movement, raising the rollers 218 in an up-and-down fashion. Although particular functions of the remote 126 are described, other functions are envisioned. For example, the remote 126 may have preset configurations to provide therapeutic relief (e.g., warm up, recovery, relax, etc.) to designated or predetermined portions of the back of the user. These different forms of therapeutic relief may provide different levels of pressure, movement, etc. across the back of the user. The remote 126 may also have a button to change the rollers 218, whereby pressing the button may cause the second carriage to 208 to move to a location at the second end 1504 to permit the rollers 218 to be interchanged. Moreover, the myofascial mat 100 may additionally or alternatively be controlled via an application operating on the mobile device 130, for example.

The remote 126 may include suitable switches, buttons, toggles, etc. to receive press input from the user via engaging with the indications. In an embodiment, the remote 126 may be battery powered, or powered via power received from the myofascial mat 100. In such instances, the remote 126 may be tethered to the myofascial mat 100 (or the base 102) via a cable.

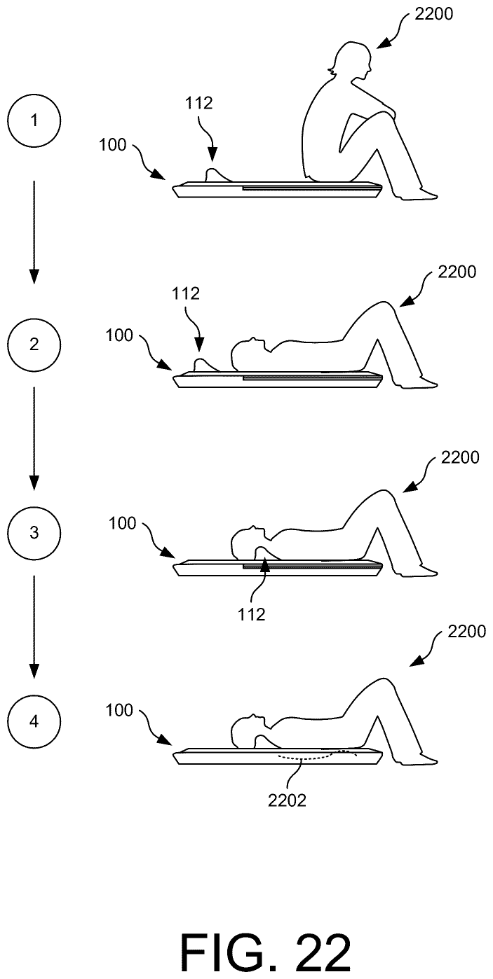

FIG. 22 illustrates an example sequence for configuring the myofascial mat 100 for a user 2200 and controlling an operation of the myofascial mat 100, according to examples of the present disclosure.

At “1” in FIG. 22, the user 2200 may sit down on the myofascial mat 100. For example, the user 2200 may sit on top of the lid 132. In an embodiment, the first carriage 206 may initially be disposed at the first end 1502.

At “2” in FIG. 22, the user 2200 may lay down on the myofascial mat 100. For example, the user 2200 may lay down over the myofascial mat 100 towards the first end 108. As the user 2200 lays back, the shoulders, sides, etc., may rest on the pieces of foam 104. Additionally, the strap 306 may support a weight of the user over the internal compartment 204. As shown at “2” the massagers 210 may be out of position and not in place next to the neck of the user 2200.

At “3” in FIG. 22, the user 2200 may adjust the massagers 210. In an embodiment, the user 2200 may adjust the massagers 210 via the remote 126. Additionally or alternatively, the myofascial mat 100 may automatically position the massagers 210. For example, the sensor(s) 120 may be used to detect the head and/or neck of the user 2200 and/or when the massagers 210 are disposed adjacent to the user 2200. Once the massagers 210 are in position, the user 2200 may save the location and/or associate the location with their profile 128. For example, using the remote 126, the user 2200 may store the location of the first carriage 206 and/or the massagers 210 and associate the location with the profile 128 of the user 2200. The massagers 210 may represent the head rest location 112 of the myofascial mat 100 on which the user 2200 lays their head.

At “4” in FIG. 22, the second carriage 208 may move along a path 2202. The path 2202, as discussed herein, may be based at least in part on the position of the first carriage 206. Moreover, the path 2202 may have different segments corresponding to the curvature of the spine of the user 2200. The user 2200 may have the ability to adjust the path 2202 and/or the segments, as well as the amount of pressure applied by the rollers 218 along the path 2202.

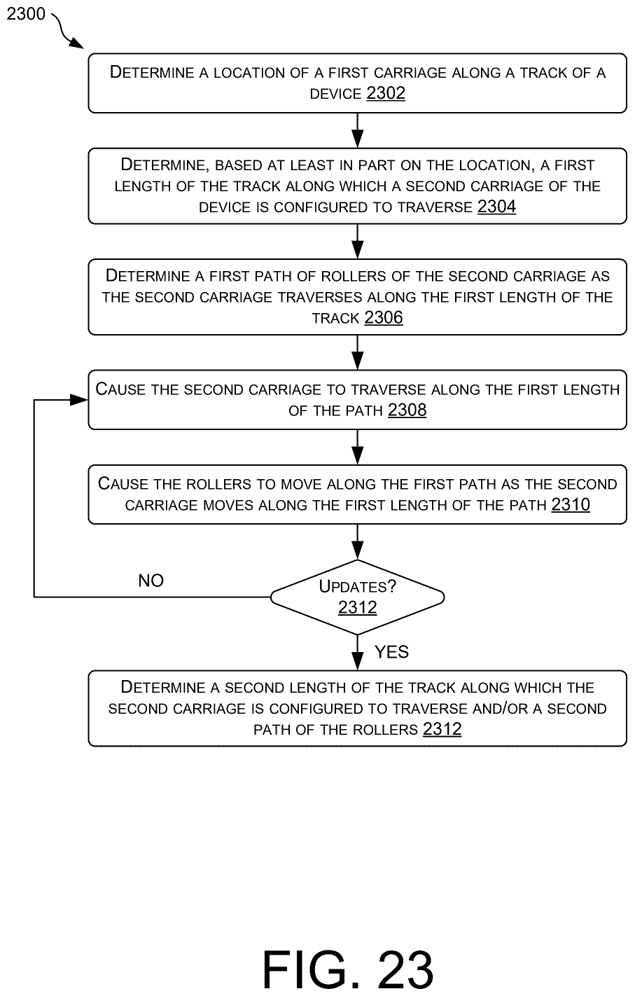

FIG. 23 illustrates example process 2300 (e.g., method) associated with controlling an operation of the myofascial mat 100, according to examples of the present disclosure. The process 2300 described herein is illustrated as collections of blocks in logical flow diagrams, which represent a sequence of operations, some or all of which may be implemented in hardware, software, or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation, unless specifically noted. Any number of the described blocks may be combined in any order and/or in parallel to implement the process 2300, or alternative processes, and not all of the blocks need be executed. For discussion purposes, the processes are described with reference to the environments, devices, architectures, diagrams, and systems described in the examples herein, such as those described with respect to FIGS. 1-22, although the process 2300 may be implemented in a wide variety of other environments, architectures, and systems.

At 2302, the process 2300 may include determining a location of a first carriage along a track of a device. For example, the location of the first carriage 206 along the track 214 (or the first rail 300 and the second rail 302) of the myofascial mat 100 may be determined. In an embodiment, the location of the first carriage 206 may be controlled via the remote 126, via information or preference(s) stored in association with the profile 128, etc. In an embodiment, the sensor(s) 120 may be used to determine when the first carriage 206 is positioned adjacent to the neck. For example, sensor data 122 generated by the sensor(s) 120 may be analyzed to determine when the first carriage 206 is adjacent to the neck of the user. The sensor(s) 120 may be used to determine the location of the first carriage 206 along the track 214.

At 2304, the process 2300 may include determining, based at least in part on the location, a first length of the track along which a second carriage of the device is configured to traverse. For example, once the location of the first carriage 206 is determined, the location may be used to determine a length of the track 214 along which the second carriage 208 traverses. In an embodiment, the length of the track 214 is disposed between the second end 1504 and the first carriage 206. The length of the track 214 along which the second carriage 208 traverses may accommodate users of different height.

At 2306, the process 2300 may include determining a first path of rollers of the second carriage as the second carriage traverses along the first length of the track. In an embodiment, the first path of the rollers 218 may be based on the length of the track 214. The first path may also be determined based on preference(s) of the user as stored in the profile 128. The first path may include different segments, along which the rollers 218 may apply different amounts of pressure to the back. For example, segments of the path may be planar, straight, curved, etc. As the second carriage 208 moves along the length of the track 214, via the first actuator 700, the second actuator 704 may actuate such that the rollers 218 move along the path.

At 2308, the process 2300 may include causing the second carriage to traverse along the first length of the path. For example, the processor(s) 114 may cause the first actuator 700 to actuate to move the second carriage 208 in the second direction 402, in the first direction 400, etc. In this manner, the second carriage 208 may move back and forth along the length of the track 214. The sensor(s) 120 may be used to determine when the second carriage 208 approaches or has arrived at ends of the length of the track 214 (e.g., adjacent to the first carriage 206 and adjacent to the second end 1504).

At 2310, the process 2300 may include causing the rollers to move along the first path as the second carriage moves along the first length of the track. For example, as the first actuator 700 moves the second carriage 208 in the first direction 400 and the second direction 402, the second actuator 704 may acuate to move the rollers 218 up and down to follow the path. Actuation of the second actuator 704 may rotate the shaft 710 and correspondingly move the first arm 600 and the second arm 602, thereby raising and lowering the rollers 218. The actuation of the second actuator 704 may be coordinated with the actuation of the first actuator 700 such that as the second carriage 208 moves along the first length of the track 214, the rollers 218 follow the path.

At 2312, the process 2300 may include determining whether there are any updates to the device. For example, using the remote 126, the user may adjust the location of the first carriage 206 along the track 214, may apply different levels of pressure via the rollers 218, thereby changing the path, may shorten the length of the track 214 to focus on a particular portion of the back, etc. Updates may also be determined if the user has shifted on the myofascial mat 100. Updates may also be made using the mobile device 130, for example, via interacting with an application operating on the mobile device 130. If at 2312, process 2300 determines that there are no updates, process 2300 may follow the “NO” route and loop to 2308. Alternatively, if updates were received, the process 2300 may follow the “YES” route and proceed to 2314.

At 2314, the process 2300 may include determining a second length of the track along which the second carriage is configured to traverse and/or a second path of the rollers. For example, if the location of the first carriage 206 on the track 214 is adjusted, a new length of the track 214 along which the second carriage 208 moves may be updated. The user may also interact with the remote 126 for causing the rollers 218 to apply increased or decreased pressure along the first path. In these instances, a second path may be determined. Alternatively, the user may adjust the length of the track 214, make the second carriage 208 stationary, etc., to focus on a particular portion of the back of the user.

While various examples and embodiments are described individually herein, the examples and embodiments may be combined, rearranged, and modified to arrive at other variations within the scope of this disclosure.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A myofascial mat comprising:
a base including:
a track, and
a gear rack;
a first carriage including:
one or more first gears engaged with the gear rack,
a first actuator engaged with the one or more first gears, wherein actuation of the first actuator causes the one or more first gears to rotate to move the first carriage along the track,
a first massager,
a second massager, and
a second actuator configured to actuate the first massager and the second massager; and
a second carriage including:
one or more second gears engaged with the gear rack,
a third actuator engaged with the one or more second gears, wherein actuation of the third actuator causes the one or more second gears to rotate to move the second carriage along the track,
a shaft,
a first arm coupled to the shaft,
a second arm coupled to the shaft,
a roller assembly having:
an axle coupled to the first arm and the second arm,
a first roller coupled to the axle, and
a second roller coupled to the axle, and
a fourth actuator engaged with the shaft, wherein actuation of the fourth actuator adjusts a position of the roller assembly.

2. The myofascial mat of claim 1, wherein:
the first arm includes a first end and a second end;
the second arm includes a first end and a second end;
the first end of the first arm couples to the shaft;
the first end of the second arm couples to the shaft;
the axle couples to the second end of the first arm; and
the axle couples to the second end of the second arm.

3. The myofascial mat of claim 1, further comprising:
a storage compartment; and
a lid coupled to the base, the lid being transitionable between an open position in which access to the storage compartment is permitted and a closed position in which access to the storage compartment is restricted,
wherein the storage compartment is configured to store a second roller assembly that is interchangeable with the roller assembly.

4. The myofascial mat of claim 1, wherein:
the track includes a first end and a second end;
the first carriage is disposed closer to the first end than the second carriage;
the second carriage is disposed closer to the second end than the first carriage; and
the second carriage is configured to move along a length of the track between the second end and the first carriage.

5. The myofascial mat of claim 1, wherein:
the track includes a first segment and a second segment;
the first segment includes a first profile;
the second segment includes a second profile that is different than the first profile; and
the first segment is longer in length than the second segment.

6. A device comprising:
a track;
a first carriage including:
one or more first massagers, and
a first actuator configured to move the first carriage along the track; and
a second carriage including:
a second actuator configured to move the second carriage along the track,
a first arm,
a second arm,
a roller assembly coupled to the first arm and the second arm, the roller assembly having:
an axle, and
one or more rollers disposed about the axle, and
a third actuator configured to move the first arm and the second arm to adjust a position of the roller assembly.

7. The device of claim 6, further comprising a gear rack, wherein:
the first carriage includes one or more first gears engaged with the first actuator and the gear rack, wherein actuation of the first actuator rotates the one or more first gears to move the first carriage along the track; and
the second carriage includes one or more second gears engaged with the second actuator and the gear rack, wherein actuation of the second actuator rotates the one or more second gears to move the second carriage along the track.

8. The device of claim 6, wherein:
the track includes a first end and a second end;
the first carriage is disposed closer to the first end than the second carriage;
the second carriage is disposed closer to the second end than the first carriage; and
the second carriage is configured to move along a length of the track between the second end and the first carriage.

9. The device of claim 6, wherein:
the one or more rollers follow a path as the second carriage moves along the track; and
the path includes:
a first segment having a first length and a first profile, and
a second segment having a second length and a second profile, the second length being less than the first length, the second profile being different than the first profile.

10. The device of claim 6, further comprising:
one or more processors, and
one or more computer-readable media storing instructions that, when executed, cause the one or more processors to perform operations including:
receiving data associated with moving the first carriage to a location along the track,
causing, based at least in part on the data and via actuation of the first actuator, the first carriage to move to the location, and
determining, based at least in part on the location, a length of the track along which the second carriage is configured to move.

11. The device of claim 10, the operations further including:
determining, based at least in part on the length of the track, a path of the one or more rollers;
determining, based at least in part on the path, a first segment of the path; and
determining, based at least in part on the path, a second segment of the path that is different than the first segment.

12. The device of claim 11, the operations further comprising:
receiving second data associated with an adjustment to the path of the one or more rollers, and
causing, based at least in part on the second data and via actuation of the third actuator, the path of the one or more rollers.

13. The device of claim 6, further comprising:
a storage compartment;
a lid that is transitionable between an open position in which access to the storage compartment is permitted and a closed position in which access to the storage compartment is restricted;
a sensor;
one or more processors, and
one or more computer-readable media storing instructions that, when executed, cause the one or more processors to perform operations including:
receiving, via the sensor, sensor data,
determining, based at least in part on the sensor data, that the lid is in the open position, and
preventing, based at least in part on the lid being in the open position, at least one of the first actuator, the second actuator, or the third actuator.

14. The device of claim 6, wherein:
the track includes:
a first rail having:
a first portion, and
a second portion, and
a second rail having:
a first portion, and
a second portion;
the first portion of the first rail and the first portion of the second rail have a first shape; and
the second portion of the first rail and the second portion of the second rail have a second shape different than the first shape.

15. The device of claim 6, further comprising:
one or more processors, and
one or more computer-readable media storing instructions that, when executed, cause the one or more processors to perform operations including:
receiving data associated with a profile of a user, and
causing, based at least in part on the profile, the first actuator to move the first carriage to a location along the track.

16. A device comprising:
a track;
a first carriage configured to be disposed at different locations along the track;
a second carriage configured to move along the track, the second carriage including:
an actuator configured move the second carriage along the track, and
a roller assembly having:
an axle, and
one or more rollers disposed about the axle,
one or more processors, and
one or more computer-readable media storing instructions that, when executed, cause the one or more processors to perform operations including:
receiving data associated with a location of the first carriage along the track,
determining, based at least in part on the location, a length of the track along which the second carriage is configured to move, and
causing, based at least in part on actuation of the actuator, the second carriage to move along the length of the track.

17. The device of claim 16, wherein:
the track includes a first end and a second end;
the first carriage is disposed closer to the first end than the second carriage;
the second carriage is disposed closer to the second end than the first carriage;
the length of the track is disposed between the first carriage and the second end; and
the second carriage is configured to move in a first direction towards the first carriage and a second direction away from the first carriage along the length of the track.

18. The device of claim 16, wherein:
the second carriage includes:
a shaft,
a first arm coupled to the shaft,
a second arm coupled to the shaft, and
a second actuator configured to rotate the shaft;
the roller assembly couples to the first arm and the second arm; and
a position of the roller assembly is adjusted during rotation of the shaft.

19. The device of claim 18, wherein:
the first arm includes a first slot;
the second arm includes a second slot;
a first pin is disposed through the first slot;
a second pin is disposed through the second slot; and
during rotation of the shaft:
the first pin translates between ends of the first slot, and
the second pin translates between ends of the second slot.

20. The device of claim 16, further comprising:
a second actuator configured move the first carriage along the track;
a storage compartment;
a lid transitionable between an open position in which access to the storage compartment is permitted, and a closed position in which access to the storage compartment is restricted;
a sensor;
one or more processors, and
one or more computer-readable media storing instructions that, when executed, cause the one or more processors to perform operations including:
receiving, via the sensor, sensor data,
determining, based at least in part on the sensor data, that the lid is in the open position, and
based at least in part on the lid being in the open position, at least one of:
causing the actuator to move the second carriage to a location along the track in which the roller assembly is accessible via opening of the lid, or
refraining from causing the second actuator to actuate.
